(19) United States
(12) Patent Application Publication
(10) Pub. No.: US 2026/0084192 A1
(43) Pub. Date: Mar. 26, 2026

(54) SYSTEM AND METHOD FOR CLEANING A BUCKET USED FOR PROCESSING FOOD WASTE

(71) Applicant: Food Cycle Science Corporation, Ottawa (CA)

(72) Inventors: Thanh TANG, Ottawa (CA); Bradley Michael Campbell CREPEAU, Ottawa (CA); Kien Manh VU, Ottawa (CA)

(21) Appl. No.: 18/891,172

(22) Filed: Sep. 20, 2024

(51) Int. Cl. B08B 9/087; A46B 13/02; B02C 23/00; B08B 13/00

(52) U.S. Cl. CPC B08B 9/087; A46B 13/02; B02C 23/00; B08B 13/00; A46B 2200/3073; B08B 2209/08

(57) ABSTRACT

An apparatus for cleaning a bucket of a food processor. The apparatus can include a base element and a grinder attachment attached to the base element. One of the base element and the grinder attachment can include a cavity that is complementary to a portion of the grinder. The grinder attachment comprising a cleaning element for cleaning the bucket of the food processor. After using the food processor, a user can seat the grinder attachment on the grinder and then rotate the grinder attachment which can have one or more sets of bristles to clean the interior of the bucket after processing food either for preparation of the food or recycling the food.

### FIELD OF THE INVENTION

The present disclosure relates to food processors that convert waste food to compost and further to new innovations related to a new device or component for cleaning a bucket used in a food processor.

### BACKGROUND

Waste food processors continue to gain traction in the marketplace. Food processors typically will receive waste food and process the waste food to generate essentially an organic dirt byproduct which can be easily discarded. A food processor can reduce waste volume in the process by 90% and create a disinfected, odorless and nutrient-rich soil that can be used in a garden. Food processors typically include features such as a heating component, a bucket, a grinding mechanism, and a fan that causes airflow through the bucket to remove moisture from the waste food as it is being processed.

One challenge with respect to using food processors is that after food is recycled in the food processor, the bucket can remain dirty. Normally, the person using the food processor will remove the bucket and clean the bucket by hand. This can be a time consuming and difficult process.

### BRIEF SUMMARY

What is needed in the art is a new component or device that can be used to enable a user of a food processor to easily clean the bucket of the food processor. This disclosure introduces new designs and features associated with a cleaning component or cleaning tool for a food processor. The food processor can be either configured to process waste food in which the food processor can include other elements like a heating element, filter, and so forth. The food processor can also include an apparatus like a blender that is used to process food for a meal.

The principles could also be used for other devices that utilize a bucket and a grinder for processing some other material other than food but also require cleaning. In some aspects, the broader principle disclosed herein relate to an attachment or cleaning accessory (generally, a cleaning tool) that is configured to interface inside the bucket. The cleaning tool, in some aspects, can be used to supplement a cleaning process and would increase the frequency of blade rotation direction changes.

In some aspects, the techniques described herein relate to an apparatus for cleaning a bucket of a food processor, the apparatus including: a base element; and a grinder attachment attached to the base element, the grinder attachment including a cleaning element for cleaning the bucket of the food processor, wherein at least one of the base element and the grinder attachment includes a cavity that is complementary to a portion of the grinder.

In some aspects, the techniques described herein relate to an apparatus including: a base; a housing configured to be attached to the base; a bucket; a motor; a grinder mechanically connected to the motor and configured within the bucket for processing food in the bucket; a control system configured to receive input from a user and control the motor; and a cleaning tool including: a base element; and a brushing element attached to the base element, wherein at least one of the base element and the brushing element includes a cavity that is complementary to a portion of the grinder.

In some aspects, the techniques described herein relate to an apparatus including: a base; a housing configured to be attached to the base; a bucket; a motor; a grinder mechanically connected to the motor and configured within the bucket for processing food in the bucket; a cleaning tool coupled to the grinder; and a control system configured to receive input from a user and control the motor, wherein the control system is configured to: receive user input to change from a food processing mode to a cleaning mode; and implement, according the cleaning mode, operation of the motor.

In some aspects, the techniques described herein relate to a method including: receiving input from a user at a food processor; based on the input, via a control system of the food processor, placing the food processor in a cleaning mode; and operating a motor according to the cleaning mode to cause a cleaning tool coupled to a grinder of the food processor to clean a bucket of the food processor.

In some aspects, the techniques described herein relate to an apparatus for cleaning a bucket of a food processor, the apparatus including: a handle element; a base element connected to the handle element, the base element configured with a first cavity that is complementary to a first portion of a grinder configured in a bucket of a food processor; and a grinder attachment attached to the base element, the grinder attachment optionally including a second cavity that is complementary to a second portion of the grinder and the grinder attachment including a cleaning element for cleaning the bucket of the food processor.

In some aspects, the techniques described herein relate to a food processor including: a base; a housing configured to be attached to the base; a filter that receives and filters humid air during a food processing cycle; a bucket; a motor; a grinder mechanically connected to the motor and configured with at least one paddle and configured within the bucket for processing waste food in the bucket; a control system configured to receive input from a user and control the motor; and a cleaning tool including: a handle element; a base element connected to the handle element, the base element configured with a first cavity that is complementary to a first portion of the grinder; and a brushing element attached to the base element, the brushing element optionally including a second cavity that is complementary to a second portion of the grinder and the brushing element including a cleaning element for cleaning the bucket of the food processor. The handle element is optional and may or may not be used in innovation.

In some aspects, the techniques described herein relate to a method including: receiving input from a user at a food processor; based on the input, via a control system of the food processor, placing the food processor in a cleaning state; configuring a motor in the cleaning state to enable a manual rotation of a grinder in a bucket of the food processor; and cleaning the bucket of the food processor via a cleaning tool removable configured on the grinder in the bucket, the cleaning tool including a handle, a cavity complementary to the grinder, and at least one cleaning element.

In some aspects, the techniques described herein relate to a cleaning tool for cleaning a bucket of a food processor, the cleaning tool including: a handle element; a base element connected to the handle element, the base element configured with a first cavity that is complementary to a first portion of a grinder configured in a bucket of a food processor; and a grinder attachment attached to the base element, the grinder attachment including a cleaning element for cleaning the bucket of the food processor.

In some aspects, the techniques described herein relate to a method of operating a food processer in a motorized mode of cleaning. The method can include: placing a food processor in a cleaning mode, wherein the food processor includes a cleaning tool configured with at least one cleaning element and comprising a cavity complementary to a grinding tool; operating a motor to rotate, at least in one direction, the grinding tool having the cleaning tool configured thereon; and cleaning the bucket by rotating the grinding tool.

In some aspects, the techniques described herein relate to a food processor including: a bucket; a motor; a grinding tool; a cleaning tool configured with a cavity complementary to the grinding tool and comprising a cleaning element; and a control system, the control system being configured to: place the food processor in a cleaning mode, wherein the food processor is configured with the cleaning tool placed on the grinding tool; operate the motor in the cleaning mode to rotate, at least in one direction, the grinding tool having the cleaning tool configured thereon; and clean the bucket by rotating the grinding tool.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE SEVERAL VIEWS OF THE DRAWINGS

Illustrative aspects of the present application are described in detail below with reference to the following figures:

FIG. 1 illustrates an exploded view of a waste food processor in accordance with some aspects of this disclosure;

FIG. 2 illustrates a partially assembled waste food processor in accordance with some aspects of this disclosure;

FIG. 3A illustrates an assembled food processor in accordance with some aspects of this disclosure;

FIG. 3B illustrates another assembled food processor in accordance with some aspects of this disclosure;

FIG. 3C illustrates yet another assembled food processor in accordance with some aspects of this disclosure;

FIG. 3D illustrates yet another assembled food processor in accordance with some aspects of this disclosure;

FIG. 3E illustrates yet another view of a food processor in accordance with some aspects of this disclosure;

FIG. 4A illustrates an exploded view of a bucket in accordance with some aspects of this disclosure;

FIG. 4B illustrates an exploded view of the heat plate and drivetrain in accordance with some aspects of this disclosure;

FIG. 4C illustrates a cross-sectional view of a bucket in accordance with some aspects of this disclosure;

FIG. 4D illustrates an exploded view of the drivetrain and respective brackets in accordance with some aspects of this disclosure;

FIG. 4E illustrates a bucket design with internal cutting blades and teeth, according to some aspects of this disclosure;

FIG. 4F illustrates a cut-away of a bucket base with various o-rings and other structures to enable the grinding tool to be attached to the bucket, according to some aspects of this disclosure;

FIG. 4G illustrates a grinding mechanism or tool and some interior characteristics of an example bucket, according to some aspects of this disclosure;

FIG. 4H illustrates an example grinding mechanism with an open space or cavity under one of the paddles, according to some aspects of this disclosure;

FIG. 5A illustrates a cleaning tool or apparatus, according to some aspects of this disclosure;

FIG. 5B illustrates a bottom view of the cleaning tool or apparatus, according to some aspects of this disclosure;

FIG. 5C illustrates a view of the cleaning tool or apparatus being inserted onto a grinder in a bucket, according to some aspects of this disclosure;

FIG. 5D illustrates a view of the cleaning tool or apparatus as inserted onto a grinder in a bucket, according to some aspects of this disclosure;

FIG. 5E illustrates a side view of the cleaning tool or apparatus, according to some aspects of this disclosure;

FIG. 5F illustrates a view of a variation of the cleaning tool or apparatus, according to some aspects of this disclosure;

FIG. 5G illustrates a side view of the variation of the cleaning tool or apparatus, according to some aspects of this disclosure;

FIG. 5H illustrates a bottom view of the variation of the cleaning tool or apparatus, according to some aspects of this disclosure;

FIG. 5I illustrates a view of the variation of the cleaning tool or apparatus, according to some aspects of this disclosure;

FIG. 5J illustrates a cleaning tool or apparatus with a grinding element, according to some aspects of this disclosure;

FIG. 5K illustrates a cleaning tool or apparatus without a handle, according to some aspects of this disclosure;

FIG. 6A illustrates a method embodiment in accordance with some aspects of this disclosure;

FIG. 6B illustrates another method embodiment in accordance with some aspects of this disclosure;

FIG. 6C illustrates a method related to a user manually cleaning the bucket in accordance with some aspects of this disclosure; and

FIG. 7 shows an example of a system for implementing certain aspects of the present technology.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

As mentioned above, disclosed herein is an improved waste food processor with a number of new improvements over prior art systems. One issue with respect to the use of food processors is how to clean the bucket. Waste food after processing can get wedged or stuck in the grinder or in the sharp teeth or cutting members configured on an interior wall of a bucket. It may be difficult to properly clean the bucket, grinder and teeth after use. Disclosed herein is a new cleaning tool or apparatus that can is configured to be complementary to the grinder such that a user can easily position or configure the cleaning tool on the grinder and utilize one or more sets of bristles or one or more brushes on the cleaning tool to properly clean the bucket. Embodiments or aspects of the disclosure can include the cleaning tool itself, a food processor that includes a cleaning tool configured thereon, and methods of the food processer being cleaned using the cleaning tool.

The following includes a discussion of the components and features of a food processor followed by an introduction of the tool that can be configured on the grinder of the food processor for cleaning the bucket. Any food processor with the basic components of a bucket and a grinder can be used in connection with the cleaning tool. Thus, while a food processor having a particular design is disclosed, that food processor is described by way of example only and any food processor can be utilized in connection with the novel cleaning tool.

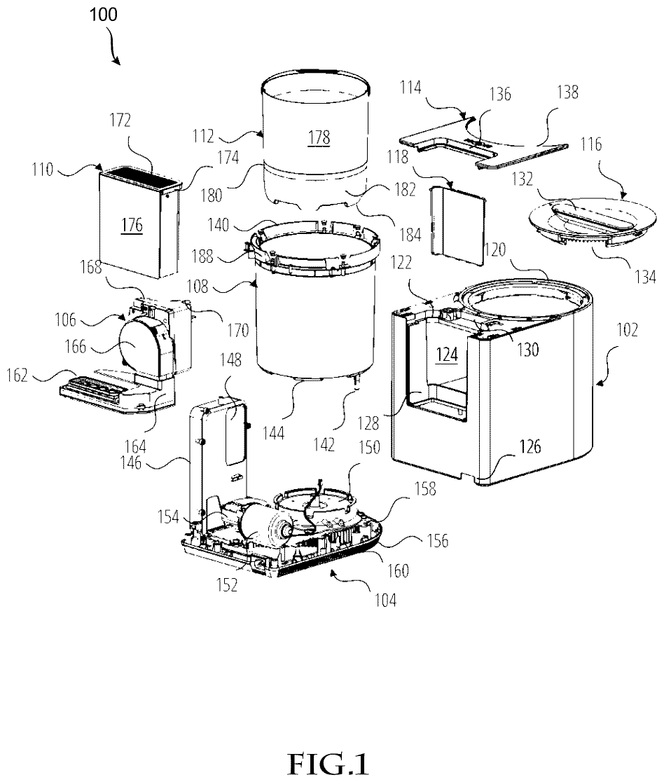

The disclosed FIG. 1 illustrates an example apparatus such as a food processor 100 in an exploded view with a variety of different components. A food processor housing 102 is shown including a housing opening 120 which is configured to receive a bucket housing 108, which in turn receives a bucket 112. The food processor housing 102 includes a filter base cavity 128 that is configured to receive a fan assembly 106. A filter cavity 124 is shown which generally represents the space where a filter will be inserted. A button board cavity 130 is shown which is an opening or cavity that holds a button electronic board that manages a touch button which can be configured on the housing cover 114. The touch button 360 can be a touch sensitive button or may require a button press. The bucket housing 108 includes a bucket top rim 140 that is configured to enable the bucket housing 108 to be attached to the food processor housing 102. A power cable opening 126 is shown in the food processor housing 102 to enable a power cord (not shown) to be inserted to power the food processor 100.

The food processor 100 disclosed represents an example apparatus that can be used in connection with the cleaning tool introduced below. Any type of processor can also be used. For example, the food processor 100 might be a blender that has a grinding element or blades used to blend food in preparation for a meal. The food processor 100 might be a waste food processor with other components such as a heating element and a filter for processing waste food. The apparatus might also have a bucket and grinding element for grinding other material such as soil, plastics, chemicals or cement. Thus, while the main example disclosed herein is the food processor 100, with its vertical bucket configuration, the principles disclosed herein with respect to a cleaning tool can apply to any kind of material processor that has a bucket of any type of configuration (i.e., at an angle or horizontal) and any kind of grinding element and that requires cleaning.

One or more base air intake openings 156 are provided in the food processor base 104. The call-out number for the base air intake openings 156 is shown at the right side of the food processor base 104. In one aspect, all of the shown base air intake openings 156 can actually draw in air into the food processor housing 102. However, an alternative approach is to only enable a portion of the base air intake openings 156 to actually let in air. For example, a set of base air intake openings 156 can be configured to be open on the right side of the food processor base 104.

The bucket housing 108 includes a bucket housing base member 144 which can be used to stabilize or position the bucket housing 108. A bucket attachment member 142 can be used to secure the bucket housing 108 to a food processor base 104. The food processor base 104 can include an attachment member receptacle 158 which is complementary to the bucket attachment member 142 to enable the bucket housing 108 to be secured to the food processor base 104. While one bucket attachment member 142 is shown as part of the bucket housing 108, other attachment members may be included as well.

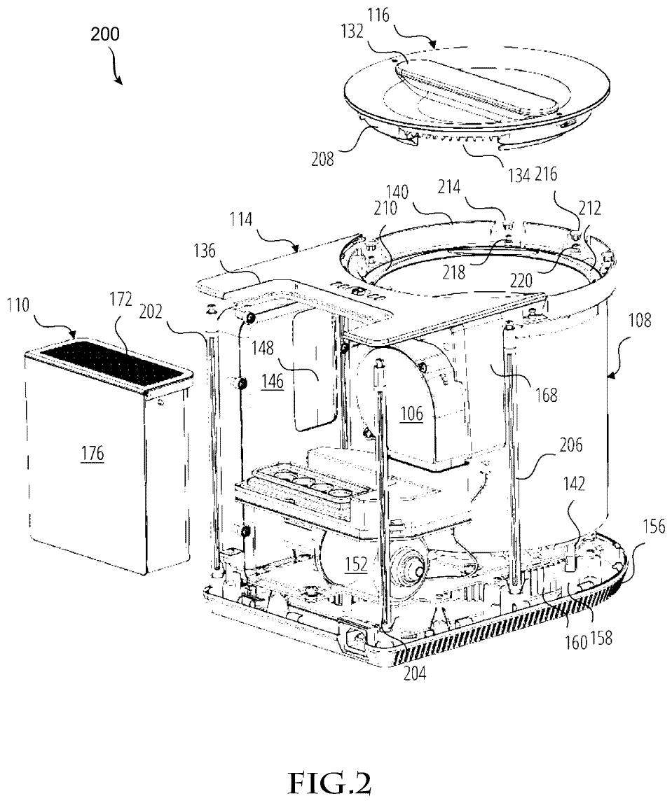

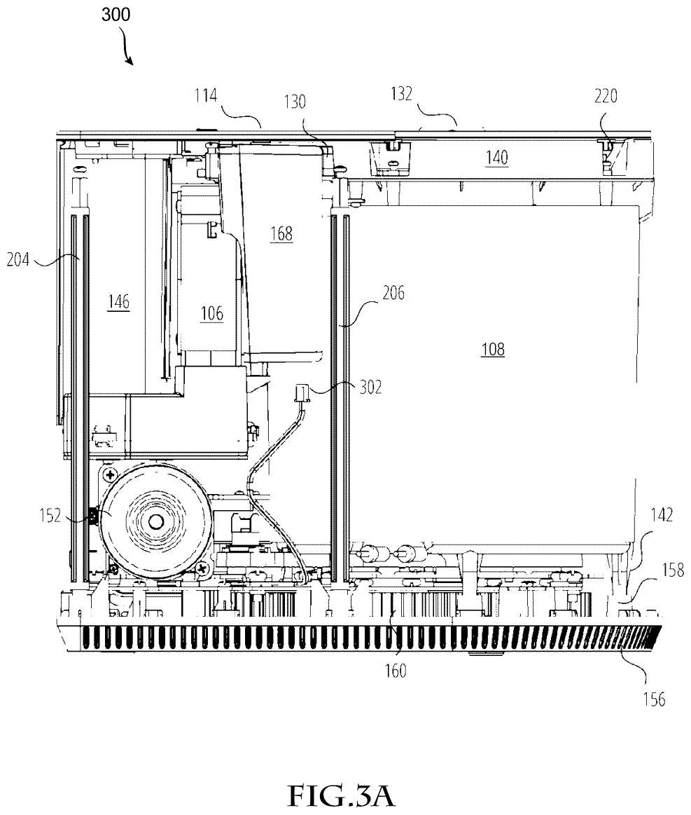

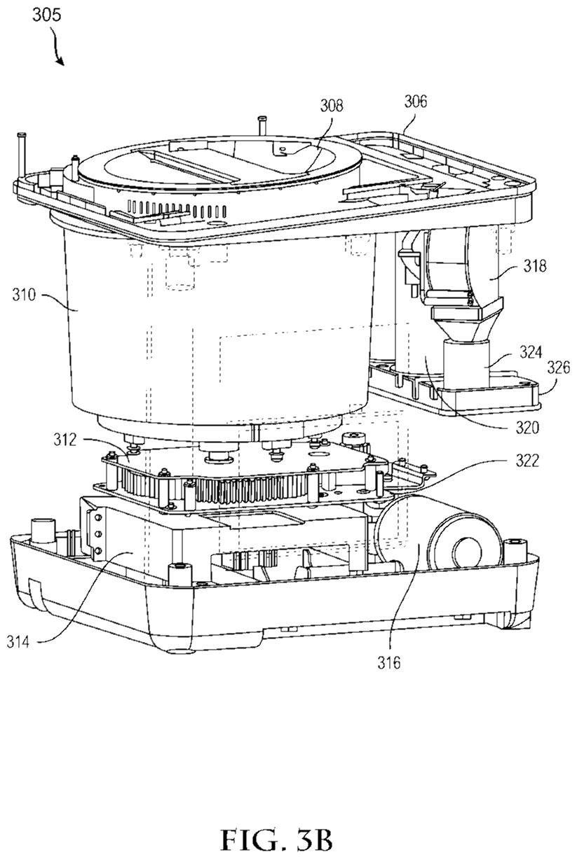

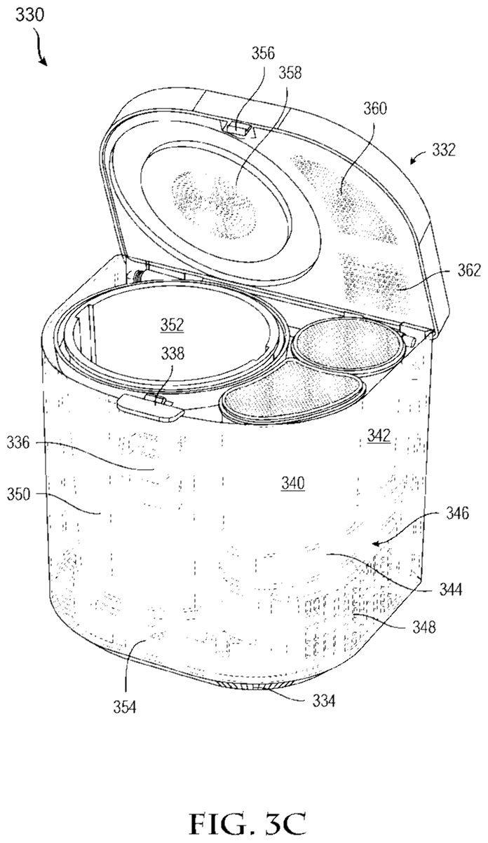

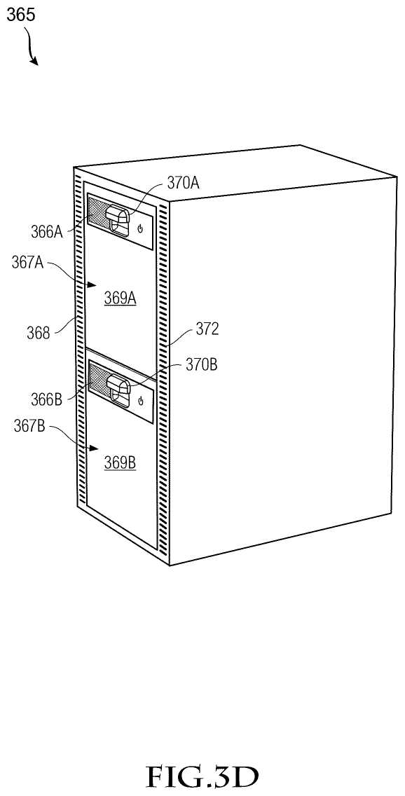

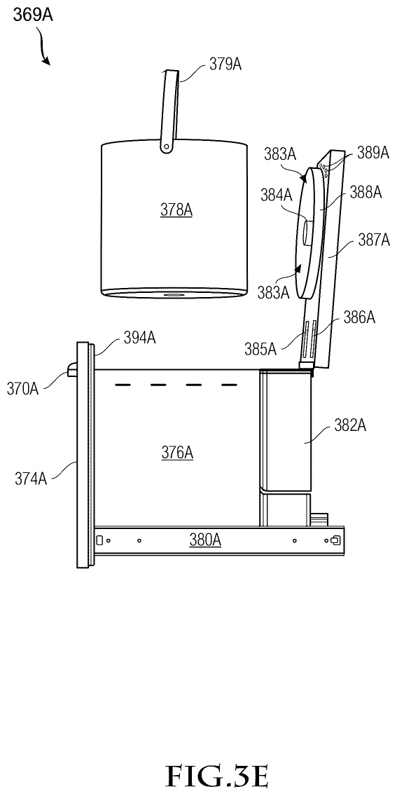

The bucket housing 108 can be used in the food processor 100 as a supporting member for infrastructure. The support feature is useful in part because of the lack of internal walls. Thus, while there are a few supporting members shown in FIGS. 2 and 3, the bucket housing 108 can be configured to be used as a supporting structure meaning that the food processor housing 102 does not need to be as strong as it otherwise might be if the food processor housing 102 was required to support the overall food processor 100.

The food processor base 104 can include other components as well. A motor 152 can be configured below and adjacent to the bucket housing 108. A transfer case 154 is shown which enables energy or power from mechanical rotation of an axle (not shown) from the motor 152 to be transferred to a drivetrain 160. The motor 152 and transfer case 154 are configured as a single unit. Above the drivetrain 160 is a heat plate 150 that can be used to transfer heat from the heat plate 150 to the bucket 112. In one aspect, the heat plate 150 and the drivetrain 160 are an integrated design in which a top piece of the drivetrain 160 acts as a stressed member which adds strength to the overall design. The drivetrain 160 and the heat plate 150 can be integrated to yield a combined structure that is configured to support the bucket housing 108. The bucket housing 108 can be floating from both the drivetrain 160 and the heat plate 150.

The various components disclosed herein are either attached to the food processor base 104 or to the food processor housing 102. For example, one or more of the bucket housing 108, the fan assembly 106, the housing cover 114 and the lid 116 can be attached to and be part of a set of housing components or shell components. The motor 152, a power transfer case such as transfer case 154 and drivetrain 160 can be attached to the food processor base 104. This disclosure is not restricted to which specific components are associated with the food processor base 104 relative to the food processor housing 102. The approach generally is that each component is part of one of the two parts and the food processor 100 can be split into the two parts with the associated components attached to the respective part.

The fan assembly 106 can include a filter base 162 that receives or is complementary to the filter assembly 110. For example, within the filter base cavity 128, a complementary member can be used to attach the fan assembly 106 to the food processor housing 102. A fan 166 can be configured as shown in FIG. 1 with a first airflow channel 164 that receives airflow from the fan 166 and causes air to flow down through the fan 166 and then up through the filter base 162 and into the filter assembly 110. The filter assembly 110 is configured on the filter base 162. The filter assembly 110 has a filter exterior surface 176 that becomes the exterior surface of the food processor housing 102 when the filter assembly 110 is positioned in place. The use of the filter exterior surface 176 as also becoming part of the exterior surface of the food processor housing 102 is one example of how the components disclosed herein more efficiently combine to make the food processor 100.

A second airflow channel 168 brings air from a third airflow channel 170. The third airflow channel 170 receives air from the lid air flow cavity 134. Thus, when the fan 166 is on, air is drawn from the bucket 112 through the lid air flow cavity 134 to the third airflow channel 170. Note the shape of the third airflow channel 170 is complementary to the circular shape of the lid air flow cavity 134. The air at this stage should be humid or filled with evaporated water through the processing of the waste food in the bucket 112. The waste food is heated via the heat plate 150 and as the food processor 100 processes the waste food, the fan 166 draws the humid air out of the bucket 112. The humid air flows from the third airflow channel 170 to the second airflow channel 168 through the fan to the first airflow channel 164. The air then flows up through the filter base 162 and through the filter assembly 110. The filter top 172 has an opening that enables the filtered air to flow out into the atmosphere around the food processor 100 from a top portion of the food processor housing 102. Note that the filter top 172 is positioned adjacent to the lid 116 and note that the filter exterior surface 176 is used as the exterior surface of the food processor housing 102. A filter support flange 174 can be used to seat the filter assembly 110 in the filter cavity 124. Inside the filter assembly 110 is the actual filter which can be any type of carbon or other filter known to those of skill in the art.

The bucket housing 108 includes a bucket housing airflow opening 188 on a top portion and at an upper rim. The bucket housing airflow opening 188 is complementary to the lid air flow cavity 134 and as shall be shown below enables airflow through the food processor housing 102 and through the cavity 338.

The bucket 112 includes a top bucket portion 178, a middle bucket portion 180 and a bottom bucket portion 182. The sides of the bucket 112 are generally smooth and the bottom bucket portion 182 includes bucket base members 184 that can be used to support the bucket 112 when the bucket 112 is placed on a countertop.

The bucket 112 can be manufactured in three different portions and the different portions can be attached in the manner disclosed in later figures.

A shell access door 118 can be used to enable a person assembling the food processor 100 access to an interior portion of the food processor housing 102 to connect electrical components from the food processor housing 102 to the food processor base 104. The shell access door 118 can slide down into the shell cavity or filter cavity 124. A printed circuit board (PCB) housing or PCB housing 146 is shown which includes an access door 148 to enable access to the PCB or related electronics. In one aspect, the access door 148 may be a cutout in the cover of the PCB housing 146 that allows certain connectors to be seen and attached.

A housing cover 114 is shown with one side including a rounded edge 138 at least in part to accommodate the housing opening 120 to receive the bucket 112. A filter notch 136 is shown that is recessed to enable the filter top 172 to have access to the atmosphere to enable filtered air to escape the food processor housing 102. The lid 116 includes a lid handle 132 and the lid air flow cavity 134 that as described above provides humid air from the bucket 112 to the third airflow channel 170.

The bucket housing 108 is a supporting structure for the food processor 100 meaning it is configured to be attached to the food processor base 104 at one or more points of attachment and to be attached to the food processor housing 102 at another point of attachment, and that it provides structural support for the food processor housing 102. The configuration shown in the figures enables the food processor 100 to not need interior walls separating different components as has been used in prior art food processors. In some aspects, there are no interior walls between the motor 152 and the filter assembly 110 and no interior wall between the motor 152 and the drivetrain 160 or the bucket housing 108. Using the bucket housing 108 as a supporting structure for the food processor 100, and using the other supportive members discussed below, the overall structure can eliminate the use of interior walls from the food processor 100.

FIG. 2 illustrates a partially assembled waste food processor 200 in accordance with some aspects of this disclosure. In FIG. 2, further details of the lid 116 and other structures are shown. The lid 116 includes a lid lower circular member 208 that includes the lid air flow cavity 134 having in one example a series of optional downward projecting members to help guide the airflow to the third airflow channel 170. The lid lower circular member 208 can be vertical generally and circular in shape except for an opening defining the lid air flow cavity 134. A first support member 202, a second support member 204 and a third support member 206 provide one or more connections between the food processor base 104 and the food processor housing 102. Other connecting or support members can be used as well. In one example, there are four support members that are used.

In an alternative structure, a first sealing face 210 and a second sealing face 212 are shown which can be eccentric in shape such that a gap between the faces is reduced as the lid 116 is closed. The structure allows for a greater gap while the lid is open while still retaining the sealing benefits of having a smaller gap when the lid 116 is closed. The first sealing face 210 and/or the second sealing face 212 can deviate from a circular pattern or path. In another example, the first sealing face 210 and the second sealing face 212 (or the structures shown in the figure) can refer to the bucket handle and the bucket 112 may have a circular pattern or shape rather than an eccentric shape.

FIG. 2 also shows a first screw plug 214, a second screw plug 216 and a first screw 218 and a second screw 220 that are respectively complementary so that the bucket housing 108 can be attached to the food processor housing 102. There are a number of different ways that the connection can be established and the use of the screw configuration shown in FIG. 2 is one example.

FIG. 3A illustrates an assembled food processor 300 in accordance with some aspects of this disclosure. The various components are shown with in an assembled configuration. The food processor housing 102 is not shown to highlight the position of such components as the fan assembly 106, the bucket housing 108, the motor 152, the drivetrain 160, the bucket attachment member 142, the second support member 204, and third support member 206 and the attachment member receptacle 158.

FIG. 3A also shows an example of a sensor 302 that can be used to detect such aspects as humidity, temperature, weight or other characteristics of the waste food or components of the food processor 100. Sensor 302 can represent any sensor 302 or more than one sensor 302 positioned in any location. For example, a sensor 302 might be included in the lid 116 or inside the bucket 112 as a camera, or in other locations.

FIG. 3B illustrates another example food processor 305 in accordance with some aspects of this disclosure and which can be used in connection with a cleaning tool as disclosed herein. FIG. 3B shows a food processor 305 having a lid 308 and a supporting structure 306 for a cover (not shown) of the food processor 305. This configuration seeks to improve the volumetric efficiency in the XY direction for the bucket contained within the bucket container 310. In this example, the fan 318 and air filters 320, a first air duct 322 and second air duct 326 are positioned near the top of the unit. The motor 316 is positioned below the bucket and along a side, and in some aspects can even approaching a corner of the unit. The transfer case 314 is also positioned below the bucket and adjacent to the motor 316. A controller can also be configured below the bucket as well as the gearbox 312. Using this configuration, the bucket diameter can be increased.

Another aspect of this disclosure relates to an improvement in the chopping component or the grinding component. There are a variety of different improved configurations that will be discussed. One of the problems with other chopping or grinding components is that these may not adequately chop or grind all of the different types of waste food that are possible. For example, bones from animal waste can be difficult to chop or grind and other configurations currently used may not be sufficient to handled bones. In some cases, handling such waste food can cause food to become lodged in the bucket and grinder and thus arises the need for a cleaning tool as disclosed herein.

FIG. 3C illustrates yet another example food processor 330 in accordance with some aspects of this disclosure and which can be used in connection with a cleaning tool as disclosed herein. FIG. 3C illustrates some of the internal components of an example food processor 330. A lid 332 are provided. For example, air flowing up from the bucket 352 can enter into an airflow region via openings 358 in the lid 332. The configuration of the lid 332 can control the airflow to an exit region via openings 360 that causes the air to flow down into a component or container 340 which can, for example, contain a fan. The fan forces air into a component or container 344 and up through the filter component 342 back into the lid 332 through the region or openings 362. The openings 358, openings 360 and openings 362 can be airflow regions which can be created by forming a number of small openings or holes in a bottom surface of the lid 332 and configuring internal airflow channels within the lid 332 to control the flow of air to and from the lid 332. A locking component 356 is shown as part of the lid 332 and which is complementary to and interacts with the latch 338. The locking component 356 can be used to either lock or release the lid 332 upon interaction with the latch 338 by a user.

A latch button 336 can be used to open the lid 332 and a bucket compartment 350 is shown for storing the bucket 352. Air intake openings 334 can be provided on a base component of the example food processor 330 and a motor or other components (not shown) can be configured in a cavity 346 that can include some openings 348 to enable airflow.

The example food processor 305 and food processor 330 are shown in more detail in U.S. patent application Ser. No. 17/404,017, filed on Aug. 17, 2021, incorporated herein by reference. The incorporated patent application disclosed a food recycler or food processor that can be used in connection with the cleaning tool disclosed herein.

FIG. 3D illustrates yet another example food processor such as a dual food processor 365 in accordance with some aspects of this disclosure and which can be used in connection with a cleaning tool. An exterior view of the example food processor such as dual food processor 365 that includes two separate compartments that can share one or more food processing component. The dual food processor 365 can enable parallel processing of food waste in two or more buckets or compartments. A first food cycler 369A with a first door 367A, and a handle 370A and a second food cycler 369B with a second door 367B, and a handle 370B configured thereon. The respective handles such as handle 370A and handle 370B can be used to pull out each respective food cycler such as in the first compartment assembly 369A and the second compartment assembly 369B to access the respective first or second bucket (not shown but can be configured like bucket 112 or bucket 352). A first condenser air intake 368 is shown as well as a second condenser air intake 372. These can be used for a single heat pump (not shown) or for individual air condenser systems (not shown). A first vent 366A and a second vent 366B can be included in one aspect a filter is shown for each respective food cycler such as a first compartment assembly 369A and a second compartment assembly 369B.

FIG. 3E illustrates yet another view of a dual food processor 365 in which one of the compartments such as a first compartment assembly 369A is shown in accordance with some aspects of this disclosure and which also can be used in connection with a cleaning tool as disclosed herein. A bucket 378A having a bucket handle 379A is shown which can be placed in a bucket container 376A. The first compartment assembly 369A can include a front door 374A having a handle 370A. A door seal 394A can be used to seal the first compartment assembly 369A during a food processing cycle.

A first drawer slide 380A can be used to slide the bucket 378A in and out of a drawer opening complementary to the first compartment assembly 369A. first compartment assembly 369A can include a first condenser system 382A. The first condenser system 38A can include such components as at least one heat bump, fans or other components used for processing waste food.

A first lid 387A is shown with an intake port 385A and an exhaust port 386A. Input ports 383A in the first lid 387A are shown as being on the interior of a circular member 388A configured on the first lid 387A. The circular member 388A can be used to assist in air flow direction and to prevent air flowing into the bucket 378A from interfering with air flowing out of the bucket 378A to an output port 384A. The desire to prevent contamination of the flow of air can be useful because the input air is dry and its purpose is to draw moisture out of the food waste being processed. Accordingly, the disclosed structure can assist in keeping the input air flow and the output airflow from the bucket 378A.

In some aspects, the input air ports 389A can be configured on an exterior portion of a circular member 388A. This configuration can take further advantage of separating the input air flow from the input ports 389A and the exhaust port 384A. Further details of the example first compartment assembly 369A and the first food cycler 369A can be found in U.S. patent application Ser. No. 18/430,989 filed on Feb. 2, 2024, incorporated herein by reference. In general, the disclosure in the incorporated patent application can be one example food processor that can be used in connection with the cleaning tool disclosed herein.

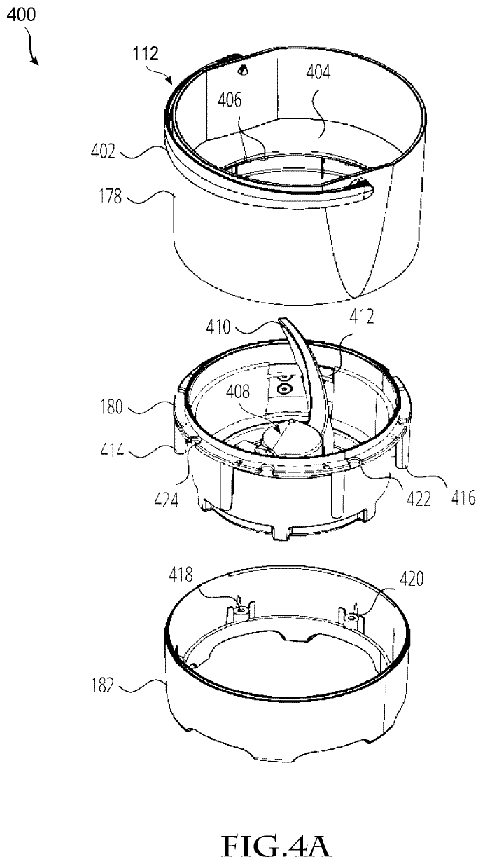

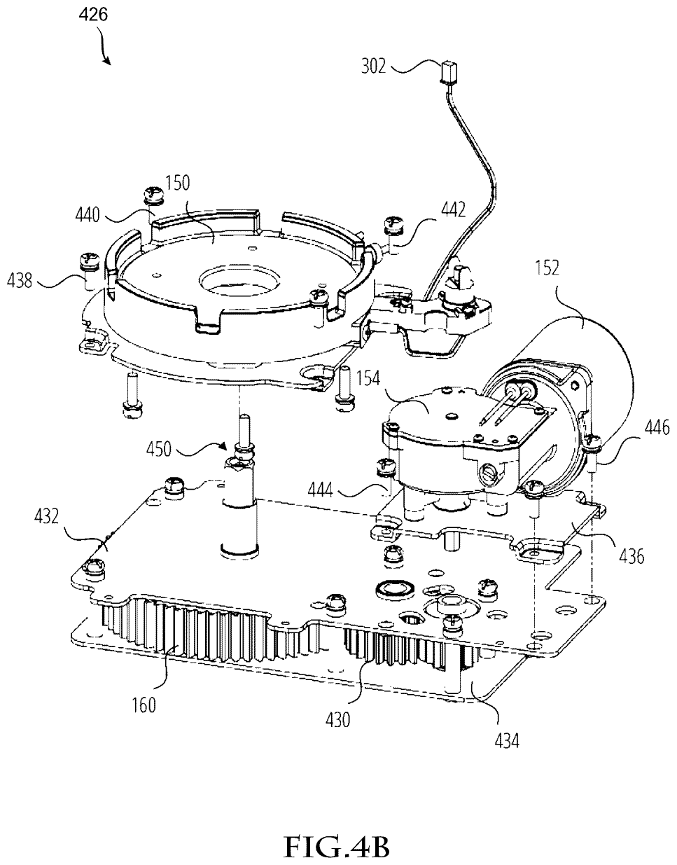

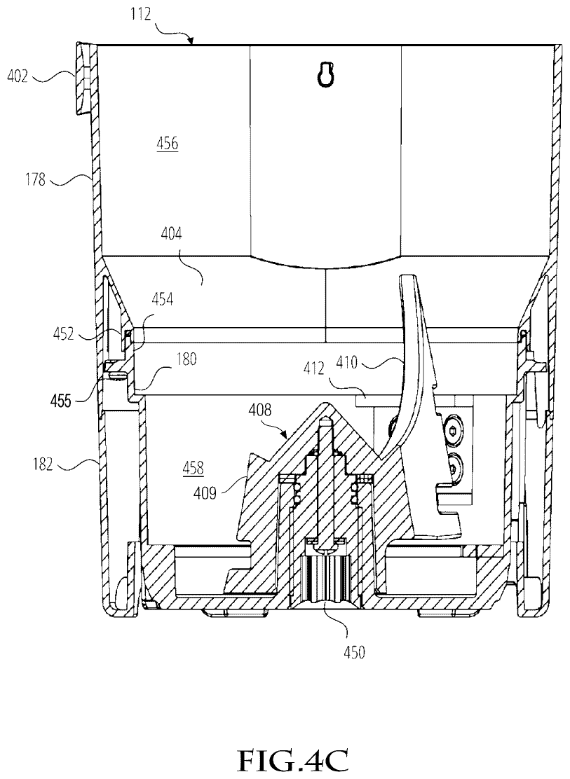

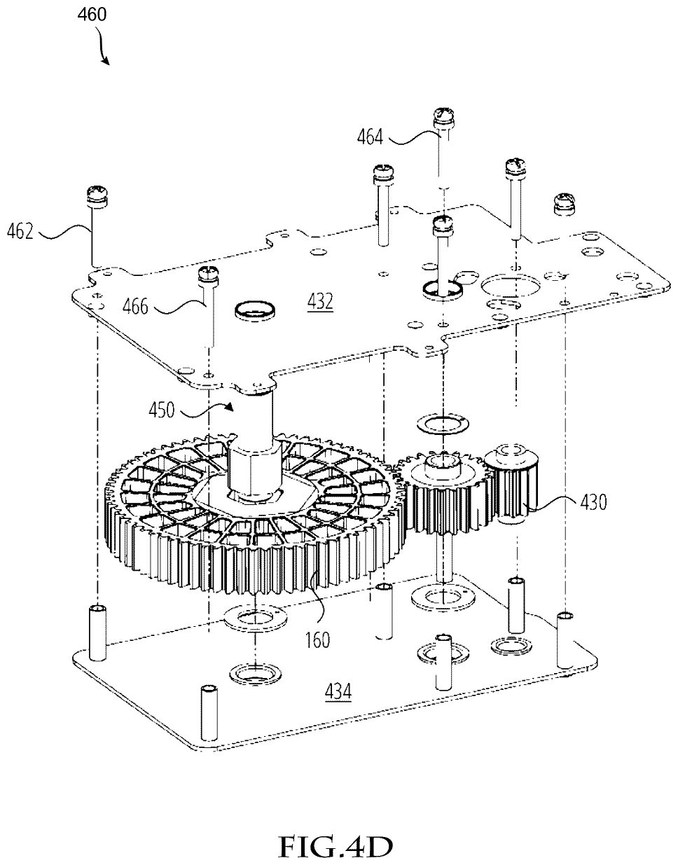

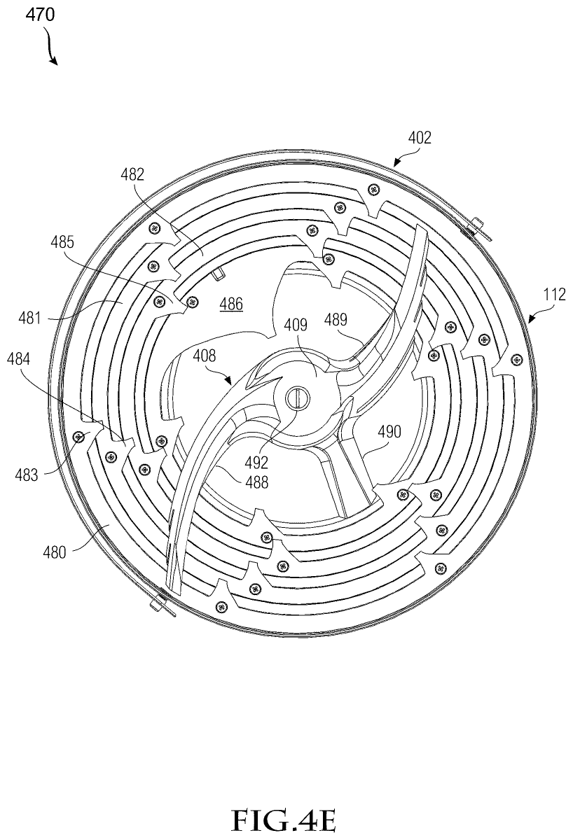

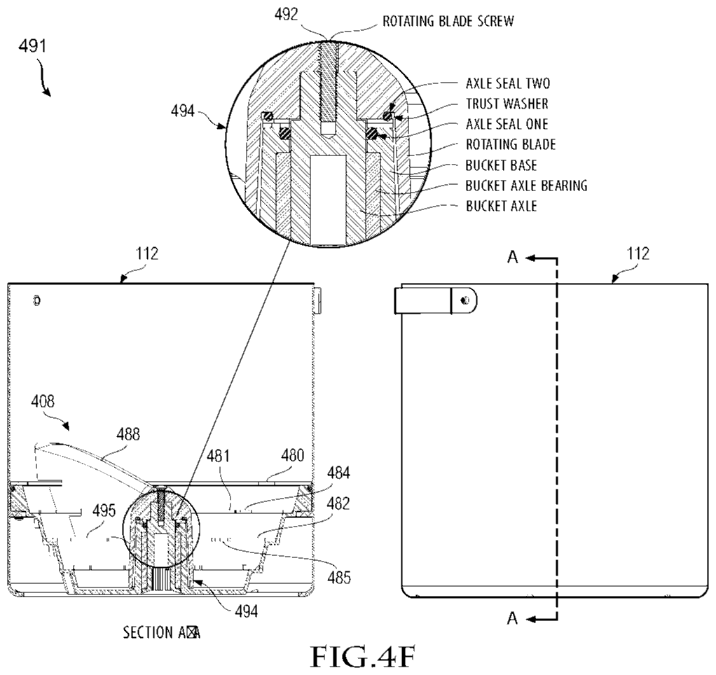

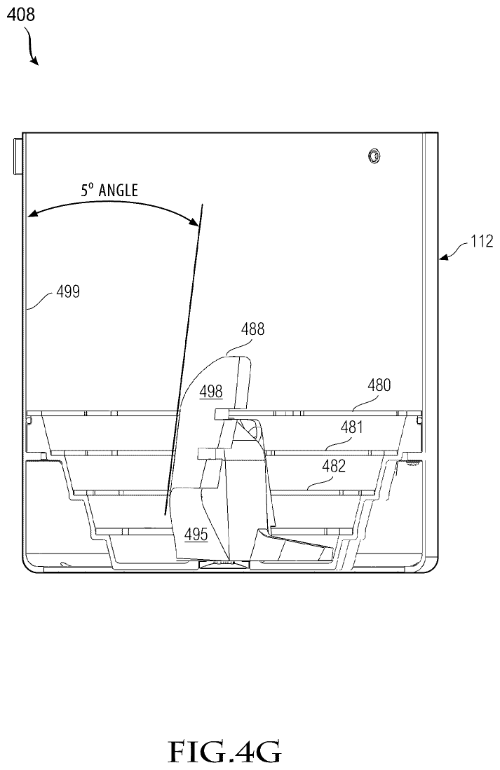

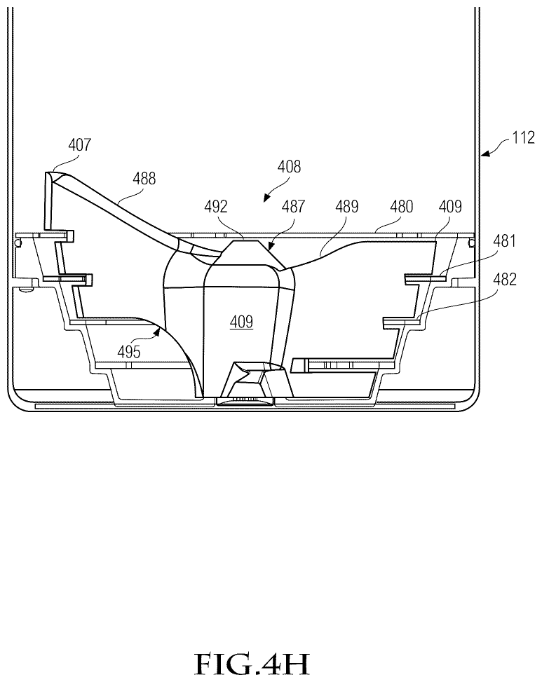

FIG. 4A illustrates an exploded view 400 of the bucket 112 in accordance with some aspects of this disclosure. The first top bucket portion 178 is shown with a bucket handle 402 and a bucket interior flange 404 that can be used to enable a bucket top portion attachment point 406 to be used to attach the middle bucket portion 180 to be attached to the top bucket portion 178. The middle bucket portion 180 is shown with a first middle portion attachment member 414 and a second middle portion attachment member 416 that can be used to receive screws to attached respectively the top bucket portion 178 to the bottom bucket portion 182.

The middle bucket portion 180 can also include a first middle portion attachment member 414 and a second middle portion attachment member 416 that can be used to attach the middle bucket portion 180 to the bottom bucket portion 182 via the first bottom portion attachment member 418 and the second bottom portion attachment member 420.

A grinder or grinding tool 408 having a grinding tool blade 410 is shown in FIG. 4A as well as an example of a type of grinding tool that can be used. The grinding tool blade 410 can also be called a paddle which can have various shapes or configurations. A cutting member 412 (which can include a plurality of cutting members) is shown extending from a side interior wall of the middle bucket portion 180. The cutting member 412 can be used or helpful in grinding the waste food during a processing cycle. There are different configurations of the grinding tool 408 and the cutting member 412. For example, U.S. patent application Ser. No. 17/404,017, filed on Aug. 17, 2021, includes a variety of different bucket designs and cutting member designs. This application is incorporated herein by reference.

In general, the new cleaning tool disclosed herein is configured to fit on the grinding tool 408 and has a shape complementary to a paddle or element of the grinding tool 408 as well as at least one cleaning element that are used to clean the cutting members. Note as well that the at least one cleaning element is also configured to be complementary (such as being tapered) to a configuration of one or more sets of cutting members.

FIG. 4A further shows the bottom bucket portion 182 which can include a first bottom portion attachment member 418 and a second bottom portion attachment member 420 which can be used to attach the bottom bucket portion 182 to the middle bucket portion 180.

FIG. 4B illustrates an exploded view 426 of the heat plate 150 and drivetrain 160. The drivetrain 160 can include features such as a top bracket of the drivetrain 432 and a bottom bracket of the drivetrain 434 that enables a series of gears 430 (i.e., one or more gears) to interact as driven by the motor 152 through a transfer case 154. A drive column 450 rotates to cause the grinding tool 408 to grind food in the bucket 112. Screws 438, 440, 442 are shown to attach the heat plate 150 to the top brackets of the drivetrain 432. A motor bracket 436 is attached to the motor 152 and transfer case 154. Screws 444, 446 can be used to attach the motor bracket 436 to the top bracket of the drivetrain 432. The exploded view 426 illustrates an example way in which a motor 152, a drivetrain 160 and a heat plate 150 can be assembled. Other structures are contemplated as well.

FIG. 4C illustrates a cross-sectional view of the bucket 112. Here, the bucket interior flange 404 is shown extending from an interior bucket wall 456 (of the top bucket portion 178) that is part of the top bucket portion 178. A circular notch 452 is configured as part of the bucket interior flange 404 that is complementary to a circular vertical member 454 that is configured as part of the middle bucket portion 180. The circular vertical member 454 is complementary to the circular notch 452 such that the top bucket portion 178 and the middle bucket portion 180 can be connected using one or more screws 455.

A grinding tool base 409 of the grinding tool 408 and the grinding tool blade 410 are shown as being connected to the drive column 450. The use of the cutting member 412 as extending from an interior bucket wall 458 (of the bottom bucket portion 182) is also shown. The grinding tool base 409 can have a variety of shapes and can represent a base element to which the grinding tool blade 410 is attached. The grinding tool blade 410 can also be called a paddle that extends from the grinding tool base 409 for processing the waste food or pressing the waste food against the cutting members that extend from the interior surface of the bucket 112.

FIG. 4D illustrates an exploded view of the drivetrain and set of gears 460. The top bracket of the drivetrain 432 and the bottom bracket of the drivetrain 434 are shown separated from the set series of gears 430 and the drivetrain 160. The drive column 450 is shown as well as a set of screws 462, 464, 466 which attach the top bracket of the drivetrain 432 to the bottom bracket of the drivetrain 434. Other screws are also shown.

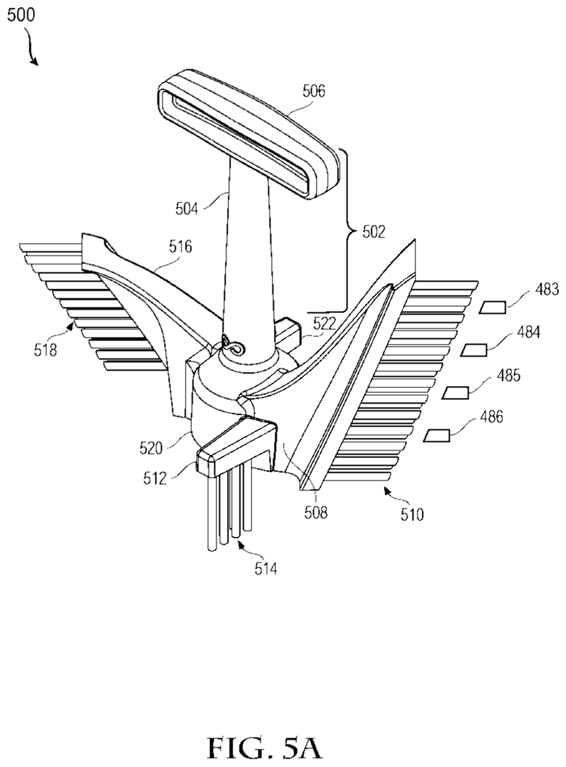

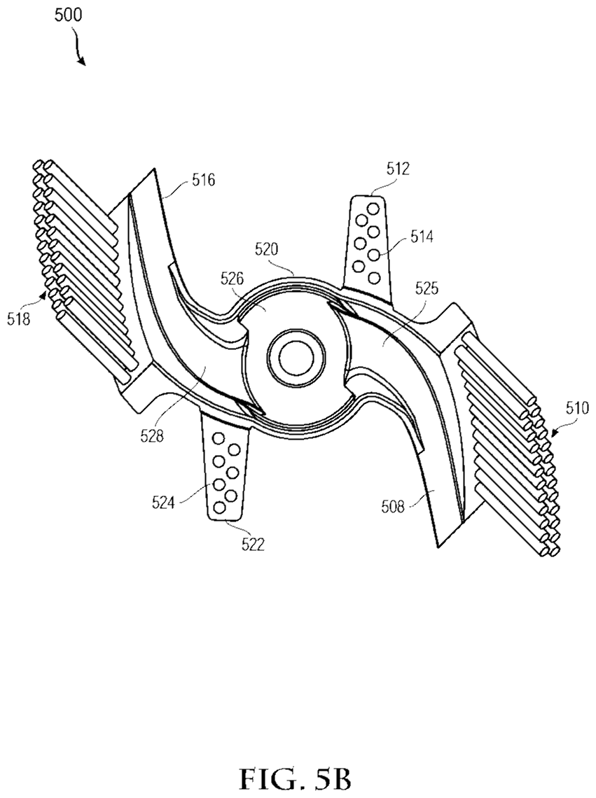

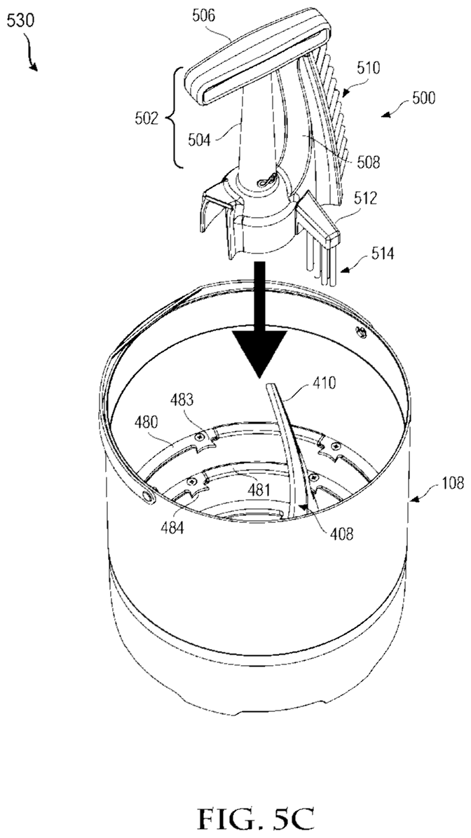

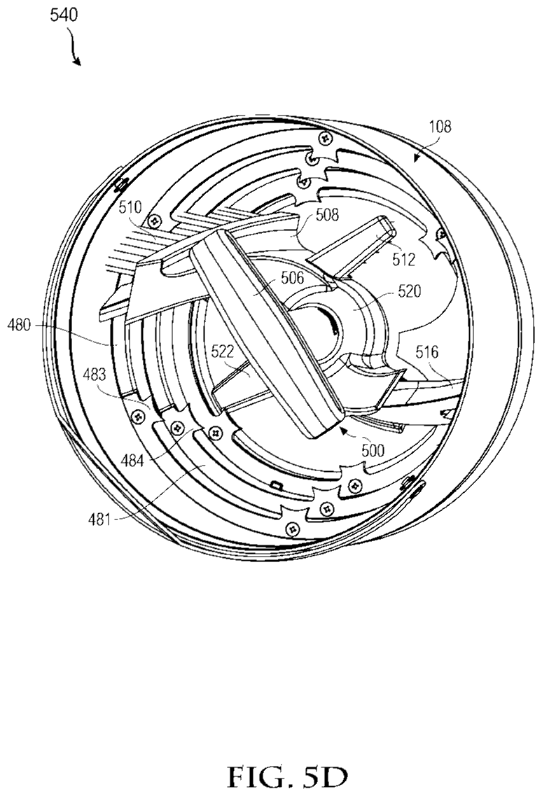

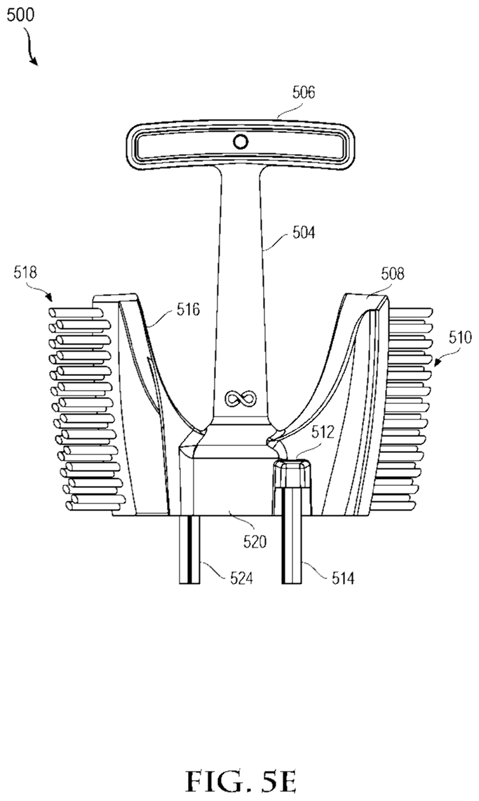

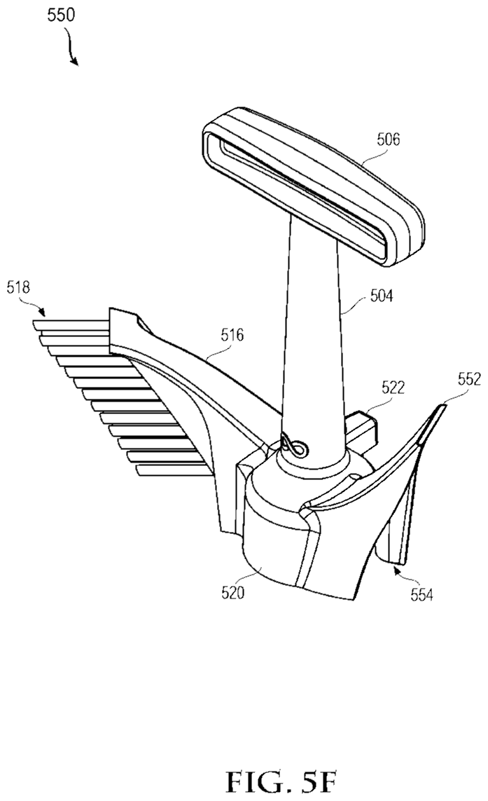

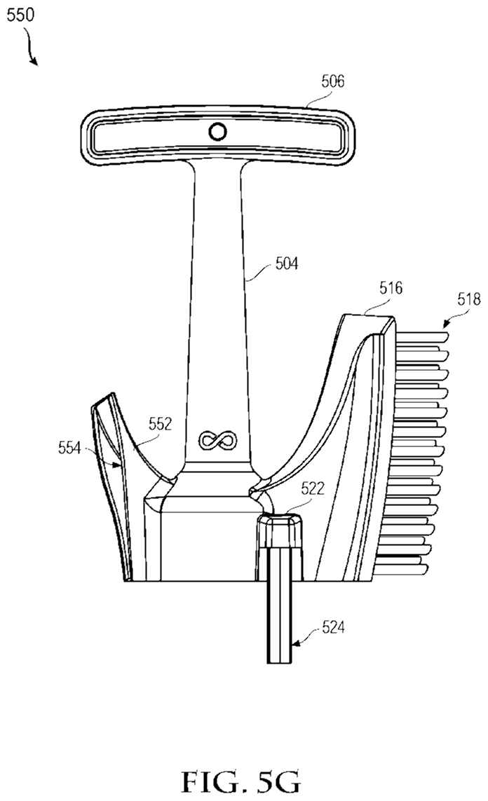

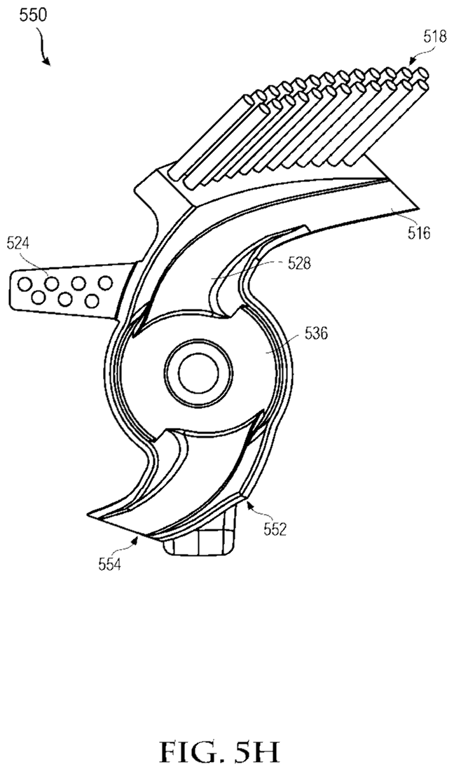

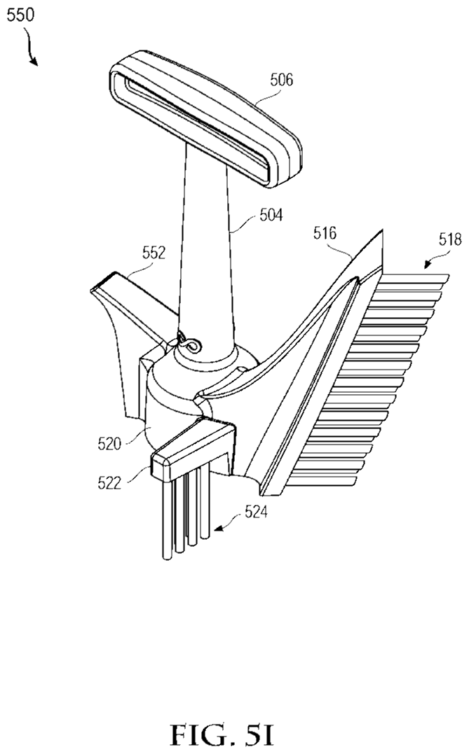

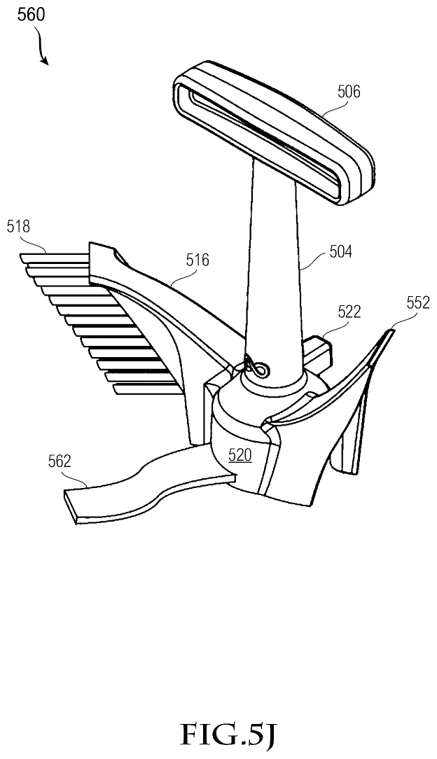

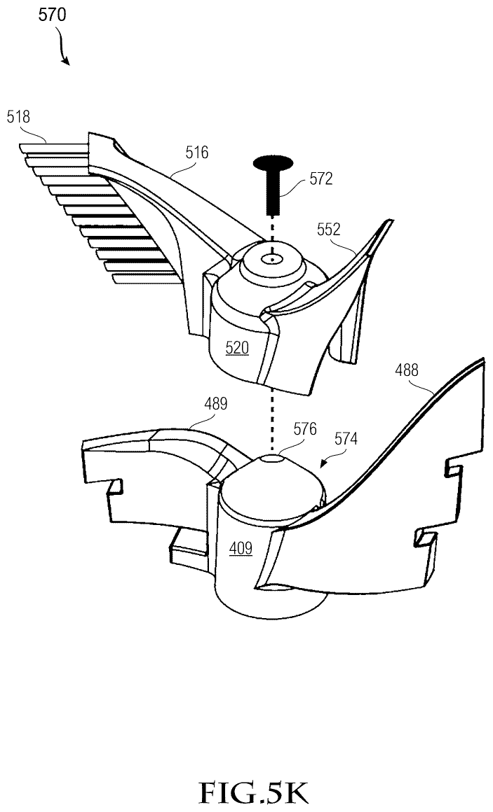

A cleaning tool (such as cleaning tool 500 shown in FIG. 5A) can have a shape or a cleaning element that are complement to one or more sets of cutting members that extend, in some cases in a stepped fashion, from an interior surface of the bucket 112.

FIG. 4E illustrates a top view 470 of the bucket 112 with a grinding mechanism or grinding tool 408 having a handle 402, a base element or grinding tool base 409, a first paddle 488, a second paddle 489 and a third paddle 490. Fixed blades 480, 481, 482 are exemplary and more blades are shown. Each of the blades is screwed into a protruding shelf of the interior surface of the bucket 112. Individual fixed teeth 483, 484, 485 are shown by way of example in connection with each set of blades such as fixed blades 480, 481, 482 with a new design to shed fiber during food processing. Note that there is a perpendicular edge and a sloped edge with a square top portion of each tooth. A lower tooth which can be one of the fixed teeth 486 is also shown which can be near the third paddle 490. A rotating blade screw 492 is used to screw in the grinding mechanism or grinding tool 408 to the bucket axil shown in FIG. 4F. The shape of the two main paddles such as the first paddle 488 and the second paddle 489 has a reduced vertical sweep angle relative to the configuration from the application incorporated herein by reference above to reduce the tendency of large round food waste such as potatoes or apples from avoiding the fixed blades and not being cut. The rotating blade screw 492 is shown to attach the grinding tool 487 to the bucket 112.

The base element or grinding tool base 409 and various paddles are shown by way of example. The cleaning tool disclosed herein will have complementary elements to whatever shape the grinding tool 408 presents.

FIG. 4F illustrates a sectional view 491 across Section A-A of the bucket 112. The view shows one of the paddles such as the first paddle 488 of the grinding tool 408. A bucket base 494 is shown in cut-out with the finer details shown for the rotating blade screw 492 and other components such as an axle seal one, an axle seal two, a thrust washer, a rotating blade (i.e., the paddles such as the first paddle 488 and the second paddle 489), a bucket base, a bucket axle bearing and a bucket axle. The two o-rings or the axle seal one and the axle seal two are used to provide a seal to prevent liquids from leaking down through the bucket base 494. The overall shape of the bucket and the grinding tool 408 in connection with the use of the various blades, their placement and shape prevent food waste from being clumped up or having other problems in connection with processing.

FIG. 4G illustrates an example blade or first paddle 488 of a grinding tool 408 with a facing surface 498 that as shown has a configuration that makes an approximately five degree angle relative to an interior surface or wall 499 of the bucket 112. The angle can vary from two degrees to nine degrees with an optimal angle at five degrees. These are example values. For example, the configuration can make other angles besides a five degree angle or smaller or greater than two to nine degrees relative to the interior surface of the wall 499 of the bucket 112. A benefit of the chosen angle is as the grinding mechanism rotates, the angle maintains movement or flow of the waste food during processing or the churn of the waste food as the food waste is pressed against the side walls and the teeth of the various levels of blades such as fixed blades 480, 481, 482. A fixed blade or fixed teeth 486 in connection with the third paddle also brakes up clumps of food waste during processing.

Lower surface 495 on the first paddle 488 illustrates another feature. This is shown in FIG. 4H as well. A cavity or indentation on the lower portions of the first paddle 488 is defined by the lower surface 495 which leaves an opening in the grinding tool 408 for food waste to actually avoid being moved or touched by the first paddle 488 as the paddle rotates. The benefit of this structure or the larger cavity defined by the lower surface 495 is that it can help in a processing cycle to enable food waste to churn and not get clumped up at any particular location in the bucket 112. A height of the cavity defined by the surface 495 can be about equal to a narrowest portion of the first paddle 488.

FIG. 4H shows the cavity defined by the lower surface 495 of the first paddle 488. Note that the first paddle 488 and the second paddle 489 have different shapes. The first paddle 488 is taller than the second paddle 489 and extends from about a top half of a central portion of the grinding tool 408. The second paddle 489 is connected along almost the entire surface of the central portion of the grinding tool 408 and has a lower surface near a floor of the bucket 112. In contrast, the first paddle 488 extends in an opposite direction from paddle 489 and its lower surface 495 curves quickly upward rather than running parallel to the floor of the bucket 112 and thus creates a cavity under the top portion of the first paddle 488. Further, as noted above, the first paddle 488 is taller and has a distal end 407 that extends above a first set of blades such as fixed blades 480 configured on the bucket 112. The distal end of the second paddle 489 may not in one aspect extend above the first set of blades such as fixed blades 480. This difference in height of the paddles can aid in preventing the clogging or bunching of food waste during a processing cycle. The notches in the paddles 488, 489 can be complementary to the respective sets of blades or fixed blades 480, 481, 482. The rotating screw 492 as part of the base element or grinding tool base 409 or connecting to the base element or a grinding tool base 409 can be used to secure the grinding tool 408 to the bucket 112. The system such as the food processor 100 processes food waste in one aspect by using or calculating an amount of torque experienced by the system. For example, if a bone gets caught between a fixed tooth 485 and the grinding tool 408, it may damage the food processor 100 or more specially the motor or drive train. It is helpful in that scenario to reverse the motor to dislodge the food waste and avoid such damage. Torque on the paddles such as a first paddle 488 and a second paddle 489 can be calculated from a grinding motor's revolutions per minute. The control system can include algorithms to have torque limiting values as a means of protecting the motor, drivetrain and grinding system. There are different methods of determining the torque. For example, strain gauges can be implemented, electrical current sensors and a mechanism sensor could be deployed to provide a torque value to a control system. The torque can be directly measured or calculated from another known value. The food processor 100 may also sense the characteristics of the food waste such as what type of food is in the bucket 112 or other facts such as how full is the bucket 112 and based at least in part on such data can select a torque determining method. For example, a first method may be chosen if there is hard food waste such as bone while another method may be chosen for softer food waste like bread. The torque determining method or component may also be turned off during some cycles based on any number of parameters.

The food processor 100 can adjust/optimize key cycle parameters from various readings/data collected from sensors throughout the cycle from the beginning. A combination of these readings can be used to trigger the end of the cycle. In one example, the cycle can be optimized based on any combination of one or more of the following measurements: (1) Temperature at the bucket base (contact and non-contact sensors/methods); (2) Air temperatures; (3) Exhaust air temperature (once the vessel exhaust air reaches a specific temperature, the end of the cycle is reached, or a cool-down phase is started); (4) Weight (using strain gages/load cells to measure the weight during the cycle. If there is no change in weight for a sufficient time, the cycle ends, or a cool-down phase is started); (5) Humidity (the humidity of the air is measured, and if it has not changed for a sufficient period, or if it has reached a predetermined target % relative humidity or an absolute humidity value, the end of the cycle is reached, or a cool-down phase is started); (6) Torque (If the measured torque is low, then it would suggest the food waste has been grinded and dry. Torque can also be used to determine the blade rotation schedule. Low torque could indicate clumping food waste, so a blade rotation reversal would reduce clumping. Sustained high torque could indicate compacting of the food waste, so a blade rotation reversal would reduce compacting. Sudden high torque could indicate jamming of hard/tough food waste, so a blade rotation reversal would reduce jamming.); (7) Camera (visible/IR) (To see how much food has been processed or to see the temperature of the vessel or to see if the temperature of the food is homogenous; this would suggest thorough mixing and that higher heat-plate temperatures would be more effective at this point.); (8) Image processing (Image processing a picture of the food waste before and during processing the bucket, could determine food waste types, blade rotation schedule, cycle parameters such as heating, cooling, air flow rate.); (9) Water content (resistance), to determine food waste humidity, food waste contents, odors indicators (types, volatility); and (10) Motor torque measurement e.g., using the motor current draw to determine torque; Use motor RPM to determine torque). AC motors may be used rather than DC motors for the purpose of determining or calculating the torque on the system based on determining the revolutions per minute.

In one example, the food processor 100 can use image processing, machine learning or artificial intelligence such that trained models can be used to classify certain types of food waste and to predict how it will respond to processing within the bucket 112. The models could be trained on several different characteristics such as visual characteristics, processing characteristics, liquid density in the food waste, hardness (bone, bread, etc.) or other factors. The trained model could receive data from a camera or other sensor and classify the food waste, which output can then be used to determine what processing model or cycle to use. The parameters of the processing cycle could then be applied to more efficiently process the food. The food processor 100 can implement different cycles depending on various factors. For example, an “eco” cycle may be used, or if in a closed-loop configuration the food processor 100 may generate too much heat for a room in which the food processor 100 is in, and so forth. Different cycle profiles can be implemented manually or automatically based on a number of factors which can be based on one or more of such parameters as room temperature, energy usage for a cycle, type of system (closed-loop or open-loop), outside temperature, time of day, historical use, food waste weight or other characteristics, predicted future use of the system 100, and so forth. For example, if the bucket 112 is full and about to process food waste, and the food processor 100 predicts through a machine learning model or based on a cycle profile that an accelerated requirement for processing waste food is coming (the dinner hour of a restaurant is 45 minute away), then the system may choose a faster food processing cycle to get ready for additional cycles.

In one aspect, there can be multiple processing modes (fast, eco, enzyme safe, etc.). The food processor 100 can features multiple processing modes by adjusting one or more parameters: heater temperature; processing air temperature; airflow; bucket rotation schedule (forward for a period of time, backwards for a period of time, etc.); and processing modes that are user selected.

FIGS. 5A and 5B illustrate a cleaning tool 500 or apparatus, according to some aspects of this disclosure. The cleaning tool 500 can include a handle element 502 that includes, for example, a shaft 504 and a handle 506. The shaft 504 can be attached to a base element 520 of the cleaning tool 500. The base element 520 can be configured with a first cavity 526 that is complementary to a first portion of a grinder or grinding tool 408 configured in a bucket 112 of a food processor 100. The first portion can be a grinding tool base 409 of the grinder or grinding tool 408. Note that all the shapes of these components are disclosed just by way of example only. The more general concept is that the cleaning tool 500 will have base element 520 with a first cavity 526 that enables that portion of the cleaning tool 500 to fit in a complementary way over the grinding tool base 409.

The handle element may be optional in some cases. For example, the cleaning tool 500 may be attached to the grinding tool 408 and clipped on or configured in a way that there is simply no handle element 502 that the user grasps to rotate the cleaning tool 500. There may be other elements or components that are useful for the purpose of attaching the cleaning tool 500 to the grinding tool 408 but that are not used or needed for the user to rotate the cleaning tool 500 for cleaning the bucket 112.

Note as well that in some cases, the term “base element 520” might, when there is no handle, refer to the structure shown in FIGS. 5A and 5B as well as other portions or structures that may include at least a portion of the handle element 502 as well. For example, the other components that might be used to enable the user to attach the cleaning tool 500 to the grinding tool 408 might be part of the base element 520 that can have extending therefrom a cleaning element.

The cleaning tool 500 can include a grinder attachment 508 attached to the base element 520. The grinder attachment 508 can include a second cavity 525 that is complementary to a second portion of the grinder or grinding tool 408. The cleaning tool 500 can include a cleaning element 510 for cleaning the bucket 112 of the food processor 100. Note that FIGS. 5A and 5B illustrates a cleaning tool 500 with four components including grinder attachment 508, cleaning component 512 with a cleaning element 514, a grinder attachment 516 with a cleaning element 518 and a cleaning component 522 with a cleaning element 52.

Note that the cleaning component 512 and the cleaning component 522 are not configured to be complementary to or fit over a paddle or feature of the grinding tool 408. These components are mainly configured to hold cleaning elements such as cleaning element 514 and cleaning element 524. The cleaning elements such as cleaning element 510, cleaning element 514, cleaning element 518, and cleaning element 524 can be a set of bristles, a respective brush, a squeegee-type cleaning element with a rubber blade that can have a straight surface or a surface or edge configured to be complementary to cutting members configured on the bucket 112, or any other type of cleaning element that can be used to clean the bucket 112.

The cleaning element 510 as shown can taper or be complementary, in a vertical direction, to a set of cutting members or fixed teeth 483, 484, 485, 486. The configuration of the cleaning element 510 can vary be the general concept is to match or mirror the configuration of the set of cutting members or fixed teeth 483, 484, 485, 486 to clean efficiently the set of cutting members or fixed teeth 483, 484, 485, 486 and the adjacent areas for lodged waste food.

There are various configurations contemplated within this disclosure for the cleaning tool 500. The cleaning tool 500 for example can include one or more grinder attachment. The cleaning tool 500 includes the base element 520 that is configured to fit over of fit on the grinding tool base 409 of the grinder or grinding tool 408. The grinder attachments shown can include one or more grinder attachment. Each grinder attachment of the one or more grinder attachments can include a cleaning element that can be configured to be oriented in a generally horizontal direction, a generally vertical direction, or at an angled direction such as a forty-five degree angle or other angles. The grinder attachment 508 extends from the base element 520 and is configured to fit on a paddle of the grinding tool 408 such as first paddle 488 shown in FIG. 4H. The cleaning element 510 are configured to extend generally in a horizontal direction but also can be configured at an angle relative to the shape of a distal surface of the first paddle 488 as well as the shape of the set of cutting members or fixed teeth 483, 484, 485, 486. In this respect, the orientation of the cleaning element 510 can be determined based on a complementary shape of the first paddle 488, the distal surface of the first paddle 488 and/or the shape or configuration of the set of cutting members or fixed teeth 483, 484, 485, 486.

The cleaning component 512 extends from the base element 520 and does not have a complementary cavity in that the cleaning component 512 just includes the cleaning element 514 extending down from the cleaning component 512. The cleaning tool 500 can include one or both types of grinder attachments—those with complementary cavities associated with a paddle of the grinding tool 408 and those without such cavities. FIG. 5B shows a cavity 528 on a lower surface of the grinder attachment 516 and shows the cleaning element 518 extending from the grinder attachment 516.

In one aspect, the cleaning tool 500 can include a base element 520 configured with a first cavity that is complementary to a first portion of a grinder tool 408 configured in a bucket 112 of a food processor 100. A grinder attachment 508 can be attached to the base element 520 and the grinder attachment 508 can include a cleaning element 510 for cleaning the bucket 112 of the food processor 100. The base element 520 can include handle components or features or structures that can enable a user to attach the cleaning tool 500 to the grinding tool 408 and/or also rotate the cleaning tool 500.

FIG. 5C illustrates a view 530 of the cleaning tool 500 or apparatus being inserted onto a grinder or grinding tool 408 in a bucket 112. Typically, the user would manually position the cleaning tool 500 on the grinding tool 408. The user may be able to interact with a control interface or user interface to place the food processor 100 in a cleaning mode in which the motor 152 or gears might be disengaged from the grinding tool 408 to allow the user to rotate, using the handle 506, the cleaning tool 500 and cause the one or more sets of bristles to clean the lower portion of the bucket 112. Note that the shaft 504 of the handle element 502 is tall and can be configured to position the handle 506 near a top portion (such as in the top third or top quarter) of the bucket 112 so that the user can easily grasp the cleaning tool 500 and rotate it for cleaning purposes. This disclosure also contemplates automated approaches to attaching the cleaning tool 500 to the grinding tool 408 as well as an approach of automatically or in a motorized mode rotating the grinding tool 408 with the cleaning tool 500 attached.

FIG. 5D illustrates a view 540 of the cleaning tool 500 or apparatus as inserted onto a grinder or grinding tool 408 in a bucket 112. In this position, one can see the cleaning element 510 in contact with the various fixed teeth 483, 484 configured with the bucket 112. The grinder attachment 508 has a distal end that is complementary to the structure of the fixed teeth 483, 484 in that teeth that are deeper into the bucket 112 have a smaller diameter as shown. The cleaning element 510 generally extend horizontally but also taper or are configured to be complementary to the changing diameter of the fixed blades 480, 481 and/or the fixed teeth 483, 484. Thus, the grinder attachment 508 is configured to clean the side of the bucket 112 and the area of the fixed teeth 483, 484 with the cleaning element 510. The cleaning component 512 and/or the cleaning component 522 can be used to clean a bottom portion of the bucket 112 through the cleaning element 514 and/or the cleaning element 524. Also shown is the grinder attachment 516 which can also be used to clean the side of the bucket 112.

FIG. 5E illustrates a side view of the cleaning tool 500 or apparatus. In this example of the cleaning tool 500, there are four grinder attachments. A first set of grinder attachments can be configured such that each respective grinder attachment has a respective cavity that is complementary to a respective paddle of a first set of paddles of the grinder or grinding tool 408. Each respective grinder attachment can have a respective cleaning element that extend generally in a horizontal direction. Two grinder attachments are shown but the first set of grinder attachments could have three or more grinder attachment. Each one as well can be uniquely shaped depending on whether the respective paddles of the first set of paddles has a unique shape.

The cleaning tool 500 can include a second set of grinder attachments. Each respective grinder attachment of the second set of grinder attachments may not have respective cavities in that the second set of grinder attachments are configured to have a respective cleaning element that extend generally in a downward and vertical direction to clean a bottom portion of the bucket. The respective grinder attachment in this case does not fit over a respective paddle of the grinding tool 408.

FIG. 5F illustrates a view of a variation of the cleaning tool or apparatus. A cleaning tool 550 is shown that has a grinder attachment 516 with a cleaning element 518 and a cleaning component 522 which could have (not shown) a cleaning element 524. The cleaning tool 550 is shown with a stabilizing element 552 connected to the base element 520 of the cleaning tool 550. The stabilizing element 552 is configured with a cavity 554 configured to be complementary to at least a portion of a second paddle of the grinding tool 408. Here, the structure is simplified for the cleaning tool 550 in which the stabilizing element 552 can be used to secure the cleaning tool 550 onto the grinding tool 408 but does not have a cleaning element of full structure to completely cover the paddle of the grinding tool 408 but the stabilizing element 552 can enable the user or a mechanical device to rotate the cleaning tool 550 to clean the bucket 112.

FIG. 5G illustrates a side view of the variation of the cleaning tool or apparatus including the cleaning tool 550 showing the stabilizing element 552, a cavity 554, the s cleaning component 522 and its cleaning element 524 as well as the grinder attachment 516 and the cleaning element 518.

FIG. 5H illustrates a bottom view of the variation of the cleaning tool 550 or apparatus. The cavity 554 of the stabilizing element 552 is shown as well as a cavity 528 for the grinder attachment 516.

FIG. 5I illustrates a view of the variation of the cleaning tool 550 or apparatus. The tapering of the cleaning element 518 is shown on the grinder attachment 516 that is configured to be complementary to a paddle of the grinding tool 408 and/or a configuration of various sets of cutting members in the bucket 112. The cleaning component 522 and the cleaning element 514 are shown as well as the stabilizing element 552.

A cleaning tool 500 or a cleaning tool 550 can include a handle element 502, a base element 520 connected to the handle element 502, the base element 520 configured with a first cavity 526 that is complementary to a first portion of a grinder or grinding tool 408 configured in a bucket 112 of a food processor 100. The cleaning tool 500 or the cleaning tool 550 can further include a grinder attachment 516 attached to the base element 520, the grinder attachment 516 comprising a cleaning element 518 for cleaning the bucket 112 of the food processor 100. The cleaning element on the grinder attachment is configured in one of a horizontal direction or a vertical, downward direction. The cleaning element can be configured in the horizontal direction and the grinder attachment can include a second cavity that is complementary to a second portion of the grinding tool 408.

The cleaning tool 500 or the cleaning tool 550 can further include a first set of grinder attachments, each respective grinder attachment of the first set of grinder attachments having a respective cavity that is complementary to a respective paddle of a first set of paddles of the grinder and having a respective cleaning element that extend generally in a horizontal direction; and a second set of grinder attachments, each respective grinder attachment of the second set of grinder attachments and having a respective cleaning element that extend generally in a vertical, downward direction.

The bucket 112 used herein may be inserted into the food processor 100 or may in some cases be separate. For example, a user, when cleaning the bucket 112, may remove the bucket 112 from the food processor 100 so that they can easily insert or attach the cleaning tool 500 to the grinding tool 408 and clean the bucket as it is independent from or separated from the food processor 100.

FIG. 5J illustrates a cleaning tool 560 or apparatus with a grinding element, according to some aspects of this disclosure. In this example, many features of the cleaning tool 560 have a similar structure to other examples herein. In this case, there is a grinding element 562 that is configured to extend from the base element 520. The shaft 504 and the handle 506 are shown as well as the grinder attachment 516, the cleaning element 518 and the cleaning component. A stabilizing element 552 is shown as well. Again, an aspect of this disclosure is a cleaning tool 560 (which may or may not have a handle element 502, or a grinder attachment 516, or a stabilizing element 552) but that also include the grinding element 562 which can be used to further grind food even in the same motion or process of cleaning the bucket 112 using the cleaning tool 560.

FIG. 5K illustrates a cleaning tool 570 or apparatus without a handle, according to some aspects of this disclosure. A screw 572 can be used to attach the cleaning tool 570 to a grinder tool 574. The screw 572 can include any kind of attachment member that can be used to secure (removably) the cleaning tool 570 to the grinder tool 574. For example, an attachment member can include a pin or clip or other kind of attachment member. The grinder tool 574 can include a first paddle 488 and a second paddle 489, and a grinding tool base 409. In this case, the grinding tool base 409 is configured with an opening 576 which can be threaded or otherwise configured to receive the screw 572 to allow the cleaning tool 570 to be attached to the grinder tool 574. The stabilizing element 552 can be used to stabilize the cleaning tool 570 on the grinder tool 574. The grinder attachment 516 and cleaning element 518 can be complementary to the second paddle 489 and once attached via the screw 572, can rotate as controlled by a motor or manually to clean the bucket 112. Note that any cleaning tool disclosed herein can include a grinding element 562 or any other configuration of components.

The grinder tool 574 thus can include a complementary structure (e.g., the opening 576 or other configuration or structure) to interact with the attachment member or screw 572 of the cleaning tool 570 to secure the cleaning tool 570 to the grinder tool 574.

In some aspects, the cleaning tool 500 (or any of the cleaning tool 550, the cleaning tool 560, or the cleaning tool 570, or some other cleaning tool not shown, can be characterized as an apparatus for cleaning a bucket 112 of a food processor. As noted above, in some aspects, it does not matter what the materials is that is processed by the “food processor”. For example, it may be a material other than food. The apparatus can include a base element 520 and a grinder attachment 516 attached to the base element 520. The grinder attachment 516 can include a cleaning element 518 for cleaning the bucket 112 of the food processor, wherein at least one of the base element 520 and the grinder attachment 516 includes a cavity 528 that is complementary to a portion of the grinder or the grinder tool 574. One example grinder attachment 516 is referenced above but it could refer to any of the grinder attachments, cleaning elements and cavities disclosed herein. In some aspects, the portion of the grinder can include a paddle used to grind food in the food processor, the paddle extending from the grinder.

The cleaning element 518 can extend from the grinder attachment 516 in generally one of a horizontal direction or a vertical direction. The cleaning tool 500 can include a handle element 504, wherein the handle element comprises a handle and a shaft that connects the handle to the base element 520. The base element 520 is generally shown as centered over the grinder or grinder tool 574. However, in other embodiments, the base element 520 can be configured in one of a central axis of the bucket or in an off-center position in the bucket 112.

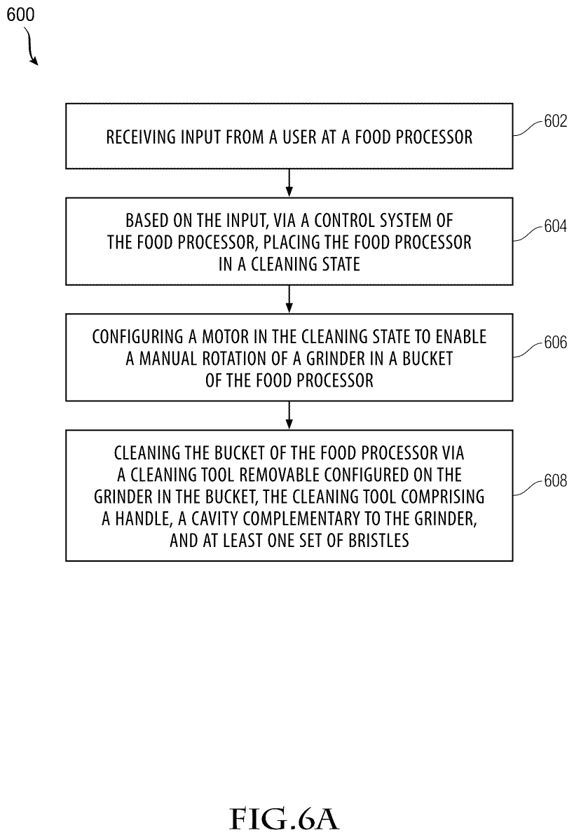

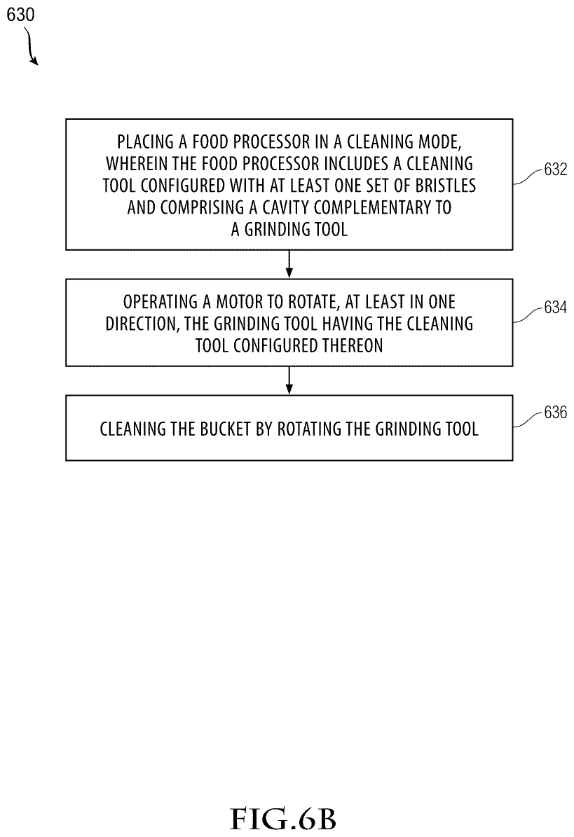

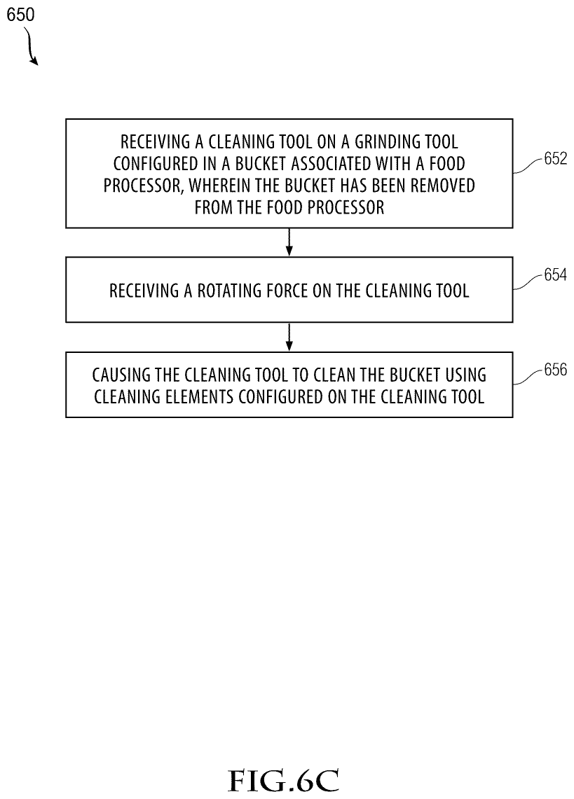

FIG. 6A illustrates a method 600 in accordance with some aspects of this disclosure. The method 600 can be practiced by a food processor 100 including any one or more of the disclosed sub-components. The method 600 can include receiving input from a user at a food processor (602). The input can relate to setting the food processor 100 in a cleaning state or any mode in which a motor or gear is disengaged from a grinding tool 408 to enable it to rotate. The method 600 can include, based on the input, via a control system of the food processor, placing the food processor in a cleaning state (604), configuring a motor in the cleaning state to enable a manual rotation of a grinder in a bucket of the food processor (606) and cleaning the bucket of the food processor via a cleaning tool removable configured on the grinder in the bucket, the cleaning tool comprising a handle, a cavity complementary to the grinder, and at least one cleaning element (608).

The cleaning tool 500 can include a first set of grinder attachments, each respective grinder attachment of the first set of grinder attachments having a respective cavity that is complementary to a respective paddle of a first set of paddles of the grinder and having a respective cleaning element that extend generally in a horizontal direction and a second set of grinder attachments, each respective grinder attachment of the second set of grinder attachments and having a respective cleaning element that extend generally in a downward direction.

The method can further include other steps that are part of a process of recycling waste food such as operating a recycling process of heating, moving a grinding tool 408, and turning on a fan 166 to break down the waste food and draw out the water content from the waste food to generate the rich organic soil or processed material. The method can include filtering and using the various components disclosed herein.

FIG. 6B illustrates another method 630 that relates to a motorized mode of cleaning the bucket 112. In this case, the method can include placing a food processor in a cleaning mode, wherein the food processor includes a cleaning tool 500 configured with at least one cleaning element and comprising a cavity complementary to a grinding tool 408 (632); operating a motor to rotate, at least in one direction, the grinding tool 408 having the cleaning tool 500 configured thereon (634); and cleaning the bucket 112 by rotating the grinding tool 408 (636). The cleaning tool 500 can have the configuration disclosed herein. A user interface can receive from a user an instruction or selection to place the food processor in the cleaning mode and then place the cleaning tool 500 on the grinding tool 408. The cleaning tool 500 in some cases may have a pin or interface with the grinding tool that confirms that it is properly positioned to avoid operating in a cleaning mode with the cleaning tool 500 not being properly seated on the grinding tool 408.

In one aspect, the food processor 100 can be configured such that the motor can move in both directions during a cleaning mode. The control system may operate the food processor 100 such that the cleaning tool 500 can be used to clean the bucket 112 by moving the cleaning element in both directions, which can be helpful in that some lodged waste food may not be captured in only one direction.

FIG. 6C illustrates another method 650 that relates to a mode of cleaning the bucket 112 in which the bucket is separate from and removed from the food processor 100. In this example, the user may remove the bucket 112 from the food processor 100, add a cleaning tool 500 with at least one grinder attachment to the grinding tool 408 and manually rotate the cleaning tool 500 to clean the bucket. The method 650 includes receiving a cleaning tool 500 on a grinding tool configured in a bucket 112 associated with a food processor 100, wherein the bucket 112 has been removed from the food processor 100 (652); receiving a rotating force on the cleaning tool 500 (654); and causing the cleaning tool 500 to clean the bucket 112 using cleaning elements configured on the cleaning tool 500 (646).

In another aspect, a method can include receiving input from a user at a food processor 100. The method can include, based on the input and via a control system of the food processor, placing the food processor in a cleaning mode and operating a motor according to the cleaning mode to cause a cleaning tool 500 coupled to a grinder or grinding tool 574 of the food processor 100 to clean a bucket 112 of the food processor 100. The cleaning tool 500 can include other elements such as a handle 504, a cavity 528 complementary to the grinder or grinding tool 574, and at least one cleaning element such as cleaning element 518. The cleaning tool 520 can include a base element 520 and a brushing element 518 and wherein at least one of the base element 520 and the brushing element 518 includes a cavity 528 that is complementary to a portion of the grinder or grinding tool 574.

The cleaning mode of the food processor 100 can cause the control system to operate the motor by one or more of: (1) changing a rotation cycle of direction of the motor; (2) turning off a heating element; (3) adjusting an amount of heat generated by the heating element; and/or (4) adjusting a cycle time for the operation of the motor relative to a food processing cycle time. Again, although food is mentioned, the apparatus used can process food or any other material and may be used for processing waste food such as a food recycler, or processing for a meal such as with a blender.

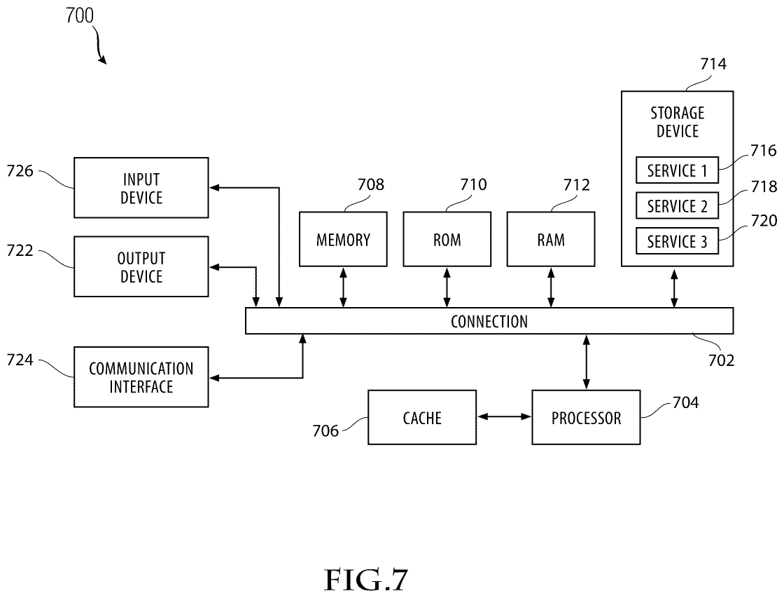

FIG. 7 shows an example of computing system 700, which can be for example any computing device making up a control system of the food processor 100, or any component thereof in which the components of the system are in communication with each other using connection 702. Connection 702 can be a physical connection via a bus, or a direct connection into processor 704, such as in a chipset architecture. Connection 702 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 700 includes at least one processing unit (CPU or processor) 704 and connection 702 that couples various system components including system memory 708, such as read-only memory (ROM) 710 and random access memory (RAM) 712 to processor 704. Computing system 700 can include a cache of high-speed memory 706 connected directly with, in close proximity to, or integrated as part of processor 704.

Processor 704 can include any general purpose processor and a hardware service or software service, such as services 716, 718, and 720 stored in storage device 714, configured to control processor 704 as well as a special-purpose processor where software instructions are incorporated into the actual processor design. Processor 704 may essentially be a completely self-contained computing system, containing multiple cores or processors, a bus, memory controller, cache, etc. A multi-core processor may be symmetric or asymmetric.

To enable user interaction, computing system 700 includes an input device 726, which can represent any number of input mechanisms, such as a microphone for speech, a touch-sensitive screen for gesture or graphical input, keyboard, mouse, motion input, speech, etc. Computing system 700 can also include output device 722, which can be one or more of a number of output mechanisms known to those of skill in the art. In some instances, multimodal systems can enable a user to provide multiple types of input/output to communicate with computing system 700. Computing system 700 can include communication interface 724, which can generally govern and manage the user input and system output. There is no restriction on operating on any particular hardware arrangement, and therefore the basic features here may easily be substituted for improved hardware or firmware arrangements as they are developed.

Storage device 714 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 714 can include software services, servers, services, etc., that when the code that defines such software is executed by the processor 704, it causes the system to perform a function. In some embodiments, a hardware service that performs a particular function can include the software component stored in a computer-readable medium in connection with the necessary hardware components, such as processor 704, connection 702, output device 722, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Claim clauses associated with the food processor and associated tools disclosed herein include several sets of clauses:

### CLAUSE SET 1

Clause 1. A food processor comprising: a base; a housing configured to be attached to the base; a bucket; a bucket housing configured receive the bucket and to be attached to the base and configured to be a supporting structure for the food processor; a lid configured on a top portion of the food processor, wherein the lid comprises a lid lower circular member on a bottom portion of the lid in which the lid lower circular member has a lid air flow cavity configured to enable humid air from the bucket to flow to a fan; and a filter that receives and filters the humid air.

Clause 2. The food processor of clause 1, wherein the filter is configured in a filter assembly that is removable and that has an exterior surface that, when installed, becomes a portion of an exterior wall of the housing.

Clause 3. The food processor of any previous clause, wherein the housing comprises no internal structural walls.

Clause 4. The food processor of any previous clause, wherein the bucket housing is configured to be a supportive structure for the food processor.

Clause 5. The food processor of any previous clause, where the food processor is separable between the base and the housing.

Clause 6. The food processor of any previous clause, wherein the lid has one of a circular or an eccentric sealing surface between the lid and the bucket.

Clause 7. The food processor of any previous clause, further comprising: a drivetrain; and a heat plate.

Clause 8. The food processor of clause 7 or any previous clause, wherein the drivetrain and the heat plate are integrated to yield an integrated structure that is configured to support the bucket housing.

Clause 9. The food processor of any previous clause, wherein an airflow path is configured to draw air from the bucket first via the lid air flow cavity, second through a fan configured adjacent to the bucket housing, third to a filter base, fourth up through a filter configured on the filter base and fifth out through a top surface of the food processor.

Clause 10. The food processor of clause 9 or any previous clause, wherein the top surface of the food processor is separate from the lid.

Clause 11. The food processor of any previous clause, wherein an airflow path is defined from an air intake opening in the base, through an internal portion of the base, up into a cavity configured between the bucket and the bucket housing, and through the lid air flow cavity to the fan and the filter.

Clause 12. A method comprising: receiving food waste in a bucket of a food processor, wherein the food processor is configured with a base, a lid and a housing; processing the food waste, wherein a fan draws humid air from a bucket via a lid air flow cavity in the lid on a bottom side of the lid; drawing the humid air through a filter assembly configured in the food processor such that a filter exterior surface of the filter assembly is configured to also become a portion of an exterior wall of the housing to generate filtered air; and causing the filtered air to exit the housing out a top surface of the housing.

Clause 13. The method of clause 12, wherein each component of the food processor is attached to either the base or the housing.

Clause 14. The method of any of clauses 12-13, wherein the top surface of the housing is separate from the lid.

Clause 15. The method of any of clauses 12-14, wherein an airflow path is configured to draw the humid air from the bucket first via the lid air flow cavity, second through a fan configured adjacent to the bucket, third to a filter base, fourth up through a filter configured on the filter base and fifth out through the top surface of the housing.

Clause 16. The method of any of clauses 12-15, wherein the food processor further comprises a bucket housing that is configured to be a supportive structure for the food processor.

Clause 17. The method of any of clauses 12-16, wherein the housing comprises no internal structural walls and wherein a bucket housing is configured to be a supportive structure in the food processor.

Clause 18. The method of any of clauses 12-17, wherein the lid is configured on a top portion of the food processor, wherein the lid comprises a lid lower circular member on a bottom portion of the lid in which the lid lower circular member has the lid air flow cavity configured to enable the humid air from the bucket to flow to a fan.

Clause 19. The method of any of clauses 12-18, wherein the filter assembly is removable.

Clause 20. The method of any of clauses 12-19, wherein the food processor comprises an integrated heat plate and drivetrain configured below the bucket.

### CLAUSE SET 2:

Clause 1. An apparatus for cleaning a bucket of a food processor, the apparatus comprising: a handle element; a base element connected to the handle element, the base element configured with a first cavity that is complementary to a first portion of a grinder configured in a bucket of a food processor; and a grinder attachment attached to the base element, the grinder attachment comprising a second cavity that is complementary to a second portion of the grinder and the grinder attachment comprising a cleaning element for cleaning the bucket of the food processor.

Clause 2. The apparatus of clause 1, wherein the second portion of the grinder comprises a paddle used to grind food in the food processor, the paddle extending from the first portion of the grinder.

Clause 3. The apparatus of clause 1, wherein the cleaning element extends from the grinder attachment in generally one of a horizontal direction or a vertical direction.

Clause 4. The apparatus of clause 1, wherein the handle element comprises a handle and a shaft that connects the handle to the base element.

Clause 5. The apparatus of clause 4, wherein, when the apparatus is configured on the grinder, the handle is positioned, based on a length of the shaft, near a top portion of the bucket.

Clause 6. The apparatus of clause 1, further comprising: a second grinder attachment, the second grinder attachment comprising a second cleaning element.

Clause 7. The apparatus of clause 6, wherein the second cleaning element extends generally downward from the second grinder attachment.

Clause 8. The apparatus of clause 1, further comprising: a stabilizing element connected to the base element of the apparatus, the stabilizing element configured with a third cavity configured to be complementary to at least a portion of a second paddle of the grinder.

Clause 9. The apparatus of clause 8, wherein the stabilizing element does not include any bristles.

Clause 10. The apparatus of clause 1, wherein the apparatus comprises: a first set of grinder attachments, each respective grinder attachment of the first set of grinder attachments having a respective cavity that is complementary to a respective paddle of a first set of paddles of the grinder and having a respective cleaning element that extend generally in a horizontal direction; and a second set of grinder attachments, each respective grinder attachment of the second set of grinder attachments and having a respective cleaning element that extend generally in a downward direction.

Clause 11. The apparatus of clause 10, wherein the first set of grinder attachments comprises at least one grinder attachment and wherein the second set of grinder attachments comprises at least one grinder attachment.

Clause 12. A food processor comprising: a base; a housing configured to be attached to the base; a filter that receives and filters humid air during a food processing cycle; a bucket; a motor; a grinder mechanically connected to the motor and configured with at least one paddle and configured within the bucket for processing waste food in the bucket; a control system configured to receive input from a user and control the motor; and a cleaning tool comprising: a handle element; a base element connected to the handle element, the base element configured with a first cavity that is complementary to a first portion of the grinder; and a brushing element attached to the base element, the brushing element comprising a second cavity that is complementary to a second portion of the grinder and the brushing element comprising a cleaning element for cleaning the bucket of the food processor.

Clause 13. The food processor of clause 12, wherein the cleaning element extends from the cleaning tool in one of generally a horizontal direction or a vertical direction.

Clause 14. The food processor of clause 12, wherein the cleaning tool comprises a second grinder attachment, the second grinder attachment comprising a second cleaning element.

Clause 15. The food processor of clause 12, wherein the cleaning tool comprises a stabilizing element connected to the base element of the cleaning tool, the stabilizing element configured with a third cavity configured to be complementary to at least a portion of a second paddle of the grinder.

Clause 16. The food processor of clause 12, wherein the cleaning tool comprises: a first set of grinder attachments, each respective grinder attachment of the first set of grinder attachments having a respective cavity that is complementary to a respective paddle of a first set of paddles of the grinder and having a respective cleaning element that extend generally in a horizontal direction; and a second set of grinder attachments, each respective grinder attachment of the second set of grinder attachments and having a respective cleaning element that extend generally in a downward direction.

Clause 17. The food processor of clause 16, wherein the first set of grinder attachments comprises at least one grinder attachment and wherein the second set of grinder attachments comprises at least one grinder attachment.

Clause 18. The food processor of clause 12, wherein the control system causes the motor to be placed in a cleaning configuration to enable a user to rotate the cleaning tool and clean the bucket.

Clause 19. A method comprising: receiving input from a user at a food processor; based on the input, via a control system of the food processor, placing the food processor in a cleaning state; configuring a motor in the cleaning state to enable a manual rotation of a grinder in a bucket of the food processor; and cleaning the bucket of the food processor via a cleaning tool removable configured on the grinder in the bucket, the cleaning tool comprising a handle, a cavity complementary to the grinder, and at least one cleaning element.

Clause 20. The method of clause 19, wherein the cleaning tool comprises: a first set of grinder attachments, each respective grinder attachment of the first set of grinder attachments having a respective cavity that is complementary to a respective paddle of a first set of paddles of the grinder and having a respective cleaning element that extend generally in a horizontal direction; and a second set of grinder attachments, each respective grinder attachment of the second set of grinder attachments and having a respective cleaning element that extend generally in a downward direction.

Clause 21. An apparatus for cleaning a bucket of a food processor, the apparatus comprising: a base element connected to the handle element, the base element configured with a first cavity that is complementary to a first portion of a grinder configured in a bucket of a food processor; and a grinder attachment attached to the base element, the grinder attachment comprising a second cavity that is complementary to a second portion of the grinder and the grinder attachment comprising a cleaning element for cleaning the bucket of the food processor.

Clause 22. The apparatus of clause 21, further comprising a handle element attached to the base element.

Clause 23. The apparatus of clause 22, wherein a handle cleaning element is configured on the handle element.

### CLAUSE SET 3

Clause 1. A cleaning tool for cleaning a bucket of a food processor, the cleaning tool comprising: a handle element; a base element connected to the handle element, the base element configured with a first cavity that is complementary to a first portion of a grinder configured in a bucket of a food processor; and a grinder attachment attached to the base element, the grinder attachment comprising a cleaning element for cleaning the bucket of the food processor.

Clause 2. The cleaning tool of clause 1, wherein the cleaning element on the grinder attachment is configured in one of a horizontal direction or a vertical, downward direction.

Clause 3. The cleaning tool of clause 2, wherein the cleaning element is configured in the horizontal direction and wherein the grinder attachment comprises a second cavity that is complementary to a second portion of the grinder.

Clause 4. The cleaning tool of clause 1, further comprising: a first set of grinder attachments, each respective grinder attachment of the first set of grinder attachments having a respective cavity that is complementary to a respective paddle of a first set of paddles of the grinder and having a respective cleaning element that extend generally in a horizontal direction; and a second set of grinder attachments, each respective grinder attachment of the second set of grinder attachments and having a respective cleaning element that extend generally in a vertical, downward direction.

Clause 5. A cleaning tool for cleaning a bucket of a food processor, the cleaning tool comprising: a base element, the base element configured with a first cavity that is complementary to a first portion of a grinder configured in a bucket of a food processor; and a grinder attachment attached to the base element, the grinder attachment comprising a cleaning element for cleaning the bucket of the food processor.

Clause 6. The cleaning tool of clause 5, further comprising a grinding element extending from the base element.

Clause 7. The cleaning tool of clause 5, further comprising: an attachment member that attaches the cleaning tool to the grinder and wherein the cleaning tool does not include a handle.

Clause 8. The cleaning tool of clause 7, wherein the attachment member comprises one of a screw and a pin.

Clause 9. The cleaning tool of clause 7, wherein the grinder comprises a complementary structure to interact with the attachment member of the cleaning tool to secure the cleaning tool to the grinder.

### CLAUSE SET 4

Clause 1. A method of operating a food processer in a motorized mode of cleaning, the method comprising: placing a food processor in a cleaning mode, wherein the food processor includes a cleaning tool configured with at least one cleaning element and comprising a cavity complementary to a grinding tool; operating a motor to rotate, at least in one direction, the grinding tool having the cleaning tool configured thereon; and cleaning the bucket by rotating the grinding tool.

Clause 2. A food processor comprising: a bucket; a motor; a grinding tool; a cleaning tool configured with a cavity complementary to the grinding tool and comprising a cleaning element; and a control system, the control system being configured to: place the food processor in a cleaning mode, wherein the food processor is configured with the cleaning tool placed on the grinding tool; operate the motor in the cleaning mode to rotate, at least in one direction, the grinding tool having the cleaning tool configured thereon; and clean the bucket by rotating the grinding tool.

### CLAUSE SET 5

Clause 1. A method comprising: receiving a cleaning tool on a grinding tool configured in a bucket associated with a food processor, wherein the bucket has been removed from the food processor; receiving a rotating force on the cleaning tool; and causing the cleaning tool to clean the bucket using cleaning elements configured on the cleaning tool.

### CLAUSE SET 6

Clause 1. An apparatus for cleaning a bucket of a food processor, the apparatus comprising: a base element; and a grinder attachment attached to the base element, the grinder attachment comprising a cleaning element for cleaning the bucket of the food processor, wherein at least one of the base element and the grinder attachment comprises a cavity that is complementary to a portion of the grinder.

Clause 2. The apparatus of clause 1, wherein the portion of the grinder comprises a paddle used to grind food in the food processor, the paddle extending from the grinder.

Clause 3. The apparatus of any previous clause, wherein the cleaning element extends from the grinder attachment in generally one of a horizontal direction or a vertical direction.

Clause 4. The apparatus of any previous clause, further comprising: a handle element, wherein the handle element comprises a handle and a shaft that connects the handle to the base element.

Clause 5. The apparatus of clause 4 or any previous clause, wherein, when the apparatus is configured on the grinder, the handle is positioned, based on a length of the shaft, near a top portion of the bucket.

Clause 6. The apparatus of any previous clause, further comprising: a second grinder attachment, the second grinder attachment comprising a second cleaning element.

Clause 7. The apparatus of clause 6 or any previous clause, wherein the second cleaning element extends generally downward from the second grinder attachment.

Clause 8. The apparatus of any previous clause, further comprising: a stabilizing element connected to the base element of the apparatus, the stabilizing element configured with a second cavity configured to be complementary to at least a portion of a second paddle of the grinder.

Clause 9. The apparatus of clause 8 or any previous clause, wherein the stabilizing element does not include any bristles.

Clause 10. The apparatus of any previous clause, wherein the apparatus comprises: a first set of grinder attachments, each respective grinder attachment of the first set of grinder attachments having a respective cavity that is complementary to a respective paddle of a first set of paddles of the grinder and having a respective cleaning element that extend generally in a horizontal direction; and a second set of grinder attachments, each respective grinder attachment of the second set of grinder attachments and having a respective cleaning element that extend generally in a downward direction.

Clause 11. The apparatus of clause 10 or any previous clause, wherein the first set of grinder attachments comprises at least one grinder attachment and wherein the second set of grinder attachments comprises at least one grinder attachment.

Clause 12. The apparatus of any previous clause, wherein the base element is configured with a base-element cavity that is complementary to a first portion of a grinder and wherein the grinder is configured in a bucket of a food processor.

Clause 13. The apparatus of any previous clause, wherein the cavity is associated with the base element and the portion comprises a first portion of the grinder and wherein the grinder attachment comprises a second cavity that is complementary to a second portion of the grinder.

Clause 14. The apparatus of any previous clause, wherein the base element is configured in one of a central axis of the bucket or in an off-center position in the bucket.

Clause 15. An apparatus comprising: a base; a housing configured to be attached to the base; a bucket; a motor; a grinder mechanically connected to the motor and configured within the bucket for processing food in the bucket; a control system configured to receive input from a user and control the motor; and a cleaning tool comprising: a base element; and a brushing element attached to the base element, wherein at least one of the base element and the brushing element comprises a cavity that is complementary to a portion of the grinder.

Clause 16. The apparatus of clause 15 or any previous clause, wherein the brushing element comprises a cleaning element that extends from the cleaning tool in one of generally a horizontal direction or a vertical direction.

Clause 17. The apparatus of clause 15 or any previous clause, wherein the cleaning tool comprises a second grinder attachment, the second grinder attachment comprising a second cleaning element.

Clause 18. The apparatus of clause 15 or any previous clause, wherein the cleaning tool comprises a stabilizing element connected to the base element of the cleaning tool, the stabilizing element configured with a third cavity configured to be complementary to at least a portion of a second paddle of the grinder.

Clause 19. The apparatus of clause 15 or any previous clause, wherein the cleaning tool comprises: a first set of grinder attachments, each respective grinder attachment of the first set of grinder attachments having a respective cavity that is complementary to a respective paddle of a first set of paddles of the grinder and having a respective cleaning element that extend generally in a horizontal direction; and a second set of grinder attachments, each respective grinder attachment of the second set of grinder attachments and having a respective cleaning element that extend generally in a downward direction.

Clause 20. The apparatus of clause 19 or any previous clause, wherein the first set of grinder attachments comprises at least one grinder attachment and wherein the second set of grinder attachments comprises at least one grinder attachment.

Clause 21. The apparatus of clause 15 or any previous clause, wherein the control system causes the motor to be placed in a cleaning configuration to enable a user to rotate the cleaning tool and clean the bucket.

Clause 22. The apparatus of clause 15 or any previous clause, wherein the apparatus comprises a waste food processor, wherein the waste food processor comprises a heating element operable to heat waste food in the bucket.

Clause 23. The apparatus of clause 15 or any previous clause, wherein the grinder is configured with a paddle and wherein the cleaning tool comprises a paddle cavity that is complementary to the paddle.

Clause 24. The apparatus of clause 15 or any previous clause, wherein the base element is configured with a base-element cavity that is complementary to a first portion of a grinder and wherein the grinder is configured in a bucket of a food processor.

Clause 25. The apparatus of clause 15 or any previous clause, wherein the cavity is associated with the base element and the portion comprises a first portion of the grinder and wherein the brushing element comprises a second cavity that is complementary to a second portion of the grinder.

Clause 26. The apparatus of clause 15 or any previous clause, wherein the base element is configured in one of a central axis of the bucket or in an off-center position in the bucket.

Clause 27. An apparatus comprising: a base; a housing configured to be attached to the base; a bucket; a motor; a grinder mechanically connected to the motor and configured within the bucket for processing food in the bucket; a cleaning tool coupled to the grinder; and a control system configured to receive input from a user and control the motor, wherein the control system is configured to: receive user input to change from a food processing mode to a cleaning mode; and implement, according the cleaning mode, operation of the motor.

Clause 28. The apparatus of clause 27, wherein the cleaning tool comprises a base element; and a brushing element attached to the base element, wherein at least one of the base element and the brushing element comprises a cavity that is complementary to a portion of the grinder.

Clause 29. The apparatus of any of clauses 27-28, wherein the operation of the motor in the cleaning mode comprises one or more of (1) changing a rotation cycle of direction of the motor; (2) turning off a heating element; (3) adjusting an amount of heat generated by the heating element; and (4) adjusting a cycle time for the operation of the motor relative to a food processing cycle time.

Clause 30. The apparatus of any of clauses 27-29, wherein the rotation cycle changes the direction of the motor more frequently relative to a food processing rotation cycle.

Clause 31. The apparatus of any of clauses 27-30, wherein adjusting the cycle time for the operation of the motor relative to the food processing cycle time comprises applying a shorter cycle time relative to the food processing cycle time.

Clause 32. The apparatus of any of clauses 27-31, wherein the cleaning tool comprises: a first set of grinder attachments, each respective grinder attachment of the first set of grinder attachments having a respective cavity that is complementary to a respective paddle of a first set of paddles of the grinder and having a respective cleaning element that extends generally in a horizontal direction; and a second set of grinder attachments, each respective grinder attachment of the second set of grinder attachments and having a respective cleaning element that extends generally in a downward direction.

Clause 33. A method comprising: receiving input from a user at a food processor; based on the input, via a control system of the food processor, placing the food processor in a cleaning mode; and operating a motor according to the cleaning mode to cause a cleaning tool coupled to a grinder of the food processor to clean a bucket of the food processor.

Clause 34. The method of clause 33, wherein the cleaning tool comprising a handle, a cavity complementary to the grinder, and at least one cleaning element.

Clause 35. The method of any of clauses 33-34, wherein the cleaning tool comprises a base element and a brushing element and wherein at least one of the base element and the brushing element comprises a cavity that is complementary to a portion of the grinder.

Clause 36. The method of any of clauses 33-35, wherein the cleaning mode causes the control system to operate the motor by one or more of: (1) changing a rotation cycle of direction of the motor; (2) turning off a heating element; (3) adjusting an amount of heat generated by the heating element; and (4) adjusting a cycle time for the operation of the motor relative to a food processing cycle time.

Clause 37. An apparatus for cleaning a bucket of a material processor, the apparatus comprising: a base element; and a grinder attachment attached to the base element, the grinder attachment comprising a cleaning element for cleaning the bucket of the material processor, wherein at least one of the base element and the grinder attachment comprises a cavity that is complementary to a portion of the grinder.

Clause 38. The apparatus of clause 37, wherein the material processor comprises a food processor or waste food processor.

Clause 39. A method comprising: receiving input from a user at a material processor; based on the input, via a control system of the material processor, placing the material processor in a cleaning mode; and operating a motor according to the cleaning mode to cause a cleaning tool coupled to a grinder of the material processor to clean a bucket of the material processor.

Clause 40. The method of clause 39, wherein the material processor comprises a food processor or waste food processor.

What is claimed is:

1. An apparatus for cleaning a bucket of a food processor, the apparatus comprising:
a base element; and
a grinder attachment attached to the base element, the grinder attachment comprising a cleaning element for cleaning the bucket of the food processor, wherein at least one of the base element and the grinder attachment comprises a cavity that is complementary to a portion of the grinder.

2. The apparatus of claim 1, wherein the portion of the grinder comprises a paddle used to grind food in the food processor, the paddle extending from the grinder.

3. The apparatus of claim 1, wherein the cleaning element extends from the grinder attachment in generally one of a horizontal direction or a vertical direction.

4. The apparatus of claim 1, further comprising:
a handle element, wherein the handle element comprises a handle and a shaft that connects the handle to the base element.

5. The apparatus of claim 4, wherein, when the apparatus is configured on the grinder, the handle is positioned, based on a length of the shaft, near a top portion of the bucket.

6. The apparatus of claim 1, further comprising:
a second grinder attachment, the second grinder attachment comprising a second cleaning element.

7. The apparatus of claim 6, wherein the second cleaning element extends generally downward from the second grinder attachment.

8. The apparatus of claim 1, further comprising:
a stabilizing element connected to the base element of the apparatus, the stabilizing element configured with a second cavity configured to be complementary to at least a portion of a second paddle of the grinder.

9. The apparatus of claim 8, wherein the stabilizing element does not include any bristles.

10. The apparatus of claim 1, wherein the apparatus comprises:
a first set of grinder attachments, each respective grinder attachment of the first set of grinder attachments having a respective cavity that is complementary to a respective paddle of a first set of paddles of the grinder and having a respective cleaning element that extend generally in a horizontal direction; and
a second set of grinder attachments, each respective grinder attachment of the second set of grinder attachments and having a respective cleaning element that extend generally in a downward direction.

11. The apparatus of claim 10, wherein the first set of grinder attachments comprises at least one grinder attachment and wherein the second set of grinder attachments comprises at least one grinder attachment.

12. The apparatus of claim 1, wherein the base element is configured with a base-element cavity that is complementary to a first portion of a grinder and wherein the grinder is configured in a bucket of a food processor.

13. The apparatus of claim 1, wherein the cavity is associated with the base element and the portion comprises a first portion of the grinder and wherein the grinder attachment comprises a second cavity that is complementary to a second portion of the grinder.

14. The apparatus of claim 1, wherein the base element is configured in one of a central axis of the bucket or in an off-center position in the bucket.

15. An apparatus comprising:
a base;
a housing configured to be attached to the base;
a bucket;
a motor;
a grinder mechanically connected to the motor and configured within the bucket for processing food in the bucket;
a control system configured to receive input from a user and control the motor; and
a cleaning tool comprising:
a base element; and
a brushing element attached to the base element, wherein at least one of the base element and the brushing element comprises a cavity that is complementary to a portion of the grinder.

16. The apparatus of claim 15, wherein the brushing element comprises a cleaning element that extends from the cleaning tool in one of generally a horizontal direction or a vertical direction.

17. The apparatus of claim 15, wherein the cleaning tool comprises a second grinder attachment, the second grinder attachment comprising a second cleaning element.

18. The apparatus of claim 15, wherein the cleaning tool comprises a stabilizing element connected to the base element of the cleaning tool, the stabilizing element configured with a third cavity configured to be complementary to at least a portion of a second paddle of the grinder.

19. The apparatus of claim 15, wherein the cleaning tool comprises:
a first set of grinder attachments, each respective grinder attachment of the first set of grinder attachments having a respective cavity that is complementary to a respective paddle of a first set of paddles of the grinder and having a respective cleaning element that extend generally in a horizontal direction; and
a second set of grinder attachments, each respective grinder attachment of the second set of grinder attachments and having a respective cleaning element that extend generally in a downward direction.

20. The apparatus of claim 19, wherein the first set of grinder attachments comprises at least one grinder attachment and wherein the second set of grinder attachments comprises at least one grinder attachment.

21. The apparatus of claim 15, wherein the control system causes the motor to be placed in a cleaning configuration to enable a user to rotate the cleaning tool and clean the bucket.

22. The apparatus of claim 15, wherein the apparatus comprises a waste food processor, wherein the waste food processor comprises a heating element operable to heat waste food in the bucket.

23. The apparatus of claim 15, wherein the grinder is configured with a paddle and wherein the cleaning tool comprises a paddle cavity that is complementary to the paddle.

24. The apparatus of claim 15, wherein the base element is configured with a base-element cavity that is complementary to a first portion of a grinder and wherein the grinder is configured in a bucket of a food processor.

25. The apparatus of claim 15, wherein the cavity is associated with the base element and the portion comprises a first portion of the grinder and wherein the brushing element comprises a second cavity that is complementary to a second portion of the grinder.

26. The apparatus of claim 15, wherein the base element is configured in one of a central axis of the bucket or in an off-center position in the bucket.

27. An apparatus comprising:
a base;
a housing configured to be attached to the base;
a bucket;
a motor;
a grinder mechanically connected to the motor and configured within the bucket for processing food in the bucket;
a cleaning tool coupled to the grinder; and
a control system configured to receive input from a user and control the motor, wherein the control system is configured to:
receive user input to change from a food processing mode to a cleaning mode; and
implement, according the cleaning mode, operation of the motor.

28. The apparatus of claim 27, wherein the cleaning tool comprises a base element; and a brushing element attached to the base element, wherein at least one of the base element and the brushing element comprises a cavity that is complementary to a portion of the grinder.

29. The apparatus of claim 27, wherein the operation of the motor in the cleaning mode comprises one or more of (1) changing a rotation cycle of direction of the motor; (2) turning off a heating element; (3) adjusting an amount of heat generated by the heating element; and (4) adjusting a cycle time for the operation of the motor relative to a food processing cycle time.

30. The apparatus of claim 29, wherein the rotation cycle changes the direction of the motor more frequently relative to a food processing rotation cycle.

31. The apparatus of claim 29, wherein adjusting the cycle time for the operation of the motor relative to the food processing cycle time comprises applying a shorter cycle time relative to the food processing cycle time.

32. The apparatus of claim 27, wherein the cleaning tool comprises:
a first set of grinder attachments, each respective grinder attachment of the first set of grinder attachments having a respective cavity that is complementary to a respective paddle of a first set of paddles of the grinder and having a respective cleaning element that extends generally in a horizontal direction; and
a second set of grinder attachments, each respective grinder attachment of the second set of grinder attachments and having a respective cleaning element that extends generally in a downward direction.

33. A method comprising:
receiving input from a user at a food processor;
based on the input, via a control system of the food processor, placing the food processor in a cleaning mode; and
operating a motor according to the cleaning mode to cause a cleaning tool coupled to a grinder of the food processor to clean a bucket of the food processor.

34. The method of claim 33, wherein the cleaning tool comprising a handle, a cavity complementary to the grinder, and at least one cleaning element.

35. The method of claim 33, wherein the cleaning tool comprises a base element and a brushing element and wherein at least one of the base element and the brushing element comprises a cavity that is complementary to a portion of the grinder.

36. The method of claim 33, wherein the cleaning mode causes the control system to operate the motor by one or more of: (1) changing a rotation cycle of direction of the motor; (2) turning off a heating element; (3) adjusting an amount of heat generated by the heating element; and (4) adjusting a cycle time for the operation of the motor relative to a food processing cycle time.
